(19) United States
(12) Patent Application Publication
(10) Pub. No.: US 2024/0333601 A1
(43) Pub. Date: Oct. 3, 2024

(54) WIRELESS NETWORK EMPLOYING NEURAL NETWORKS FOR CHANNEL STATE FEEDBACK

(71) Applicant: GOOGLE LLC, Mountain View, CA (US)

(72) Inventors: Jibing Wang, San Jose, CA (US); Erik Richard Stauffer, Sunnyvale, CA (US)

(21) Appl. No.: 18/573,994

(22) PCT Filed: Jun. 17, 2022
(86) PCT No.: PCT/US22/34060

§ 371 Date: Dec. 22, 2023

Related U.S. Application Data
(60) Provisional application No. 63/214,931, filed on Jun. 25, 2021.

(51) Int. Cl. H04L 41/16; H04W 24/02

(52) U.S. Cl. CPC H04L 41/16; H04W 24/02

(57) ABSTRACT

A wireless system employs neural networks to provide for CSI estimate feedback between a transmitting device and a receiving device. A managing component selects neural network architecture configurations for implementation at the transmitting and receiving devices based on capability information. The receiving device determines CSI estimate(s) from CSI pilot signaling from the transmitting device. The CSI estimate(s) are processed by the neural network(s) at the receiving device to generate a CSF output, which can represent, for example, one or more predicted future CSI estimates and which is wirelessly transmitted to the transmitting device. The one or more neural networks at the transmitting device then process the received CSF output along to generate one or more recovered predicted future CSI estimates, which are then used to control one or more MIMO processes at the transmitting device.

### BACKGROUND

Wireless communication systems often encounter several signal propagation challenges that are frequency-dependent, such as path loss, scattering, signal diffraction, penetration loss, and the like. Many wireless transmission schemes that rely on high frequencies, such systems compliant with the Third Generation Partnership (3GPP) Long Term Evolution (LTE) and Fifth Generation New Radio (5G NR) cellular standards or certain International Electronic and Electrical Engineers (IEEE) 802.11 wireless local area network (WLAN) standards, have employed various multiple-input-multiple-output (MIMO) techniques to mitigate such signal propagation challenges.

Many MIMO techniques, such as beamforming techniques, space-time coding techniques, and multiple-user MIMO (MU-MIMO) techniques, rely on, or at least benefit from, an understanding or characterization of how wireless signals will propagate at one or more corresponding carrier frequencies for an identified channel in the current signal propagation environment. Typically, this channel estimation is provided as channel state information (CSI). CSI often takes the form of one or more matrices, with each matrix entry storing information representative of a transfer function, or more specifically a Channel Frequency Response (CFR), for a corresponding carrier frequency. To determine the CSI for a channel, a transmitting device wirelessly transmits one or more CSI pilot symbols, such as Long Training Symbols (LTFs) for IEEE 802.11-based systems, to a receiving device, which then uses the received form of the transmitted CSI pilot symbols to calculate at least one CSI estimate for the corresponding carrier frequency used to transmit the one or more CSI pilot symbols. The receiving device can utilize the CSI estimate to manage its MIMO reception processes for the given channel. This CSI estimate may be provided wirelessly back to the transmitting device so that the transmitting device can manage one or more of its MIMO transmission processes accordingly (this feedback process typically is referred to as “channel state feedback” (CSF)).

The overall process of transmitting pilot symbols, calculating CSI estimates from the received pilot symbols, and then reporting the CSI estimates back to the transmitting device typically is implemented via an algorithmic, modular approach in which each step or stage in this process is individually “handcrafted” by one or more designers. The relative complexity of each step typically translates to commensurate complexity in designing, testing, and implementing a hard-coded implementation of the process. Moreover, the complex algorithmic calculation of the CSI estimates at the receiving device can consume significant resources of the receiving device, while frequent wireless transmission of the CSI estimates in their typical form can consume significant bandwidth in the channel connecting the receiving device to the transmitting device. As such, it can be challenging to design and implement a robust channel estimation process that is highly adaptable to changing conditions and highly efficient for reduced transmission latency and reduced resource consumption.

### SUMMARY OF EMBODIMENTS

In accordance with some embodiments, a computer-implemented method, in a first device, includes: receiving an indication of a neural network architectural configuration responsive to providing capability information representing at least one capability of the first device to an infrastructure component, implementing the neural network architectural configuration at a transmit neural network of the first device, receiving a representation of a channel status information (CSI) estimate as an input to the transmit neural network, generating, at the transmit neural network, a first output based on the representation of the CSI estimate, the first output representing a compressed version of the representation of a prediction of the CSI estimate for a future point in time, and controlling a radio frequency (RF) antenna interface of the first device to transmit a first RF signal representative of the first output for receipt by a second device.

In various embodiments, this method further can include one or more of the following aspects. The method further including algorithmically determining the CSI estimate based on one or more RF signals received from the second device. The first output further representing a prediction of the CSI estimate for a future point in time (that is, a predicted future CSI estimate). Generating the first output further including generating the first output at the transmit neural network further based on a representation of a scheduling latency of a multiple-input multiple-output (MIMO) process of the second device provided as an input to the transmit neural network. The transmit neural network receiving a representation of the scheduling latency as an input. The neural network architectural configuration being selected for the transmit neural network from a plurality of candidate neural network architectural configurations based on the scheduling latency. The at least one capability being represented by the capability information includes at least one of: an antenna capability; a processing capability; a power capability; or a sensor capability. The neural network architectural configuration being selected from a plurality of neural network architectural configurations based on at least one of: the at least one capability of the first device, at least one capability of a second device, a frequency or band of a channel represented by the CSI estimate; or a current signal propagation environment of the first device. Receiving the indication of the neural network architectural configuration including at least one of: receiving an identifier associated with one of a plurality of candidate neural network architectural configurations locally stored at the first device; or receiving data representing parameters of the neural network architectural configuration. Generating the first output including generating the first output at the transmit neural network further based on at least one of: sensor data input to the transmit neural network from one or more sensors of the first device; or at least one current operational parameter of the RF antenna interface. The method further including participating in joint training of a transmit neural network architectural configuration for the transmit neural network with a receive neural network architectural configuration for a receive neural network of the second device. The method also including: receiving a representation of a CSI pilot signal as an input of a receive neural network of the first device; and generating, at the receive neural network, a second output based on the representation of the CSI pilot signal, the second output including the representation of the CSI estimate. Generating the second output further includes generating the second output at the receive neural network based on at least one of: sensor data from one or more sensors of the first device; a carrier frequency of a channel associated with the CSI estimate; or operational parameters for an antenna interface of the first device. The transmit neural network being a deep neural network (DNN).

In accordance with some embodiments, a computer-implemented method, in a first device, includes: receiving an indication of a neural network architectural configuration responsive to providing capability information representing at least one capability of the first device to an infrastructure component; implementing the neural network architectural configuration at a receive neural network of the first device; receiving, at a radio frequency (RF) antenna interface of the first device, a first RF signal from a second device, the first RF signal representative of a compressed representation of a predicted future channel state information (CSI) estimate; providing a representation of the first RF signal as an input to the receive neural network; generating, at the receive neural network, the predicted future CSI estimate based on the input to the receive neural network; and managing at least one multiple-input multiple-output (MIMO) process at the first device based on the predicted future CSI estimate.

In various embodiments, this method further can include one or more of the following aspects. The neural network architectural configuration being selected from a plurality of neural network architectural configurations based on at least one of: the at least one capability of the first device, at least one capability of the second device, a frequency or band of a channel represented by the predicted future CSI estimate; or a current signal propagation environment of the first device. Receiving the indication of the neural network architectural configuration including at least one of: receiving an identifier associated with one of a plurality of candidate neural network architectural configurations locally stored at the first device; or receiving one or more data structures representing parameters of the neural network architectural configuration. Generating the predicted future CSI estimate includes generating the predicted future CSI estimate at the receive neural network further based on at least one of: sensor data input to the receive neural network from one or more sensors of the first device; or a current operational parameter of the RF antenna interface. The method further including participating in joint training of a neural network architectural configuration for the receive neural network with a neural network architectural configuration for a transmit neural network of the second device. The method also including: generating, at a transmit neural network of the first device, a CSI pilot signal; and controlling the RF antenna interface of the first device to transmit a second RF signal representative of the CSI pilot signal for receipt by the second device. Generating the CSI pilot signal including generating the CSI pilot signal at the transmit neural network further based on at least one of: a carrier frequency of a channel associated with the predicted future CSI estimate; or at least one operational parameter for the RF antenna interface of the first device. Generating the CSI pilot signal further includes generating the CSI pilot signal at the transmit neural network based on at least one of: sensor data from one or more sensors of the first device; a carrier frequency of a channel associated with the predicted future CSI estimate; or at least one operational parameter for an antenna interface of the first device. Generating the predicted future CSI estimate further includes generating the predicted future CSI estimate at the transmit neural network based on at least one of: sensor data from one or more sensors of the first device; a carrier frequency of a channel associated with the predicted future CSI estimate; or at least one operational parameter for the RF antenna interface of the first device. The at least one MIMO process including at least one of: a beamforming process; a space-time coding process; and a multiple-user MIMO process. The at least one capability including at least one of: an antenna capability; a processing capability; a power capability; or a sensor capability. The receive neural network including a deep neural network (DNN).

In accordance with some embodiments, a computer-implemented method includes: receiving capability information from at least one of a first device or a second device, the capability information representing at least one capability of a corresponding one of the first device or the second device; selecting a pair of neural network architectural configurations from a set of candidate neural network architectural configurations based on the capability information, the pair of neural network architectural configurations being jointly trained to implement a channel state information (CSI) estimate feedback process between the first device and the second device; transmitting to the first device a first indication of a first neural network architectural configuration of the pair for implementation at a transmit neural network of the first device; and transmitting to the second device a second indication of a second neural network architectural configuration of the pair for implementation at a receive neural network of the second device. In various embodiments, this method further can include one or more of the following aspects. The at least one capability including at least one of: an antenna capability; a processing capability; a power capability; or a sensor capability. The transmit neural network and the receive neural network each including a deep neural network (DNN).

In some embodiments, a device includes: a network interface; at least one processor coupled to the network interface; and a memory storing executable instructions, the executable instructions configured to manipulate the at least one processor to perform any of the methods described above and herein.

### BRIEF DESCRIPTION OF THE DRAWINGS

The present disclosure is better understood and its numerous features and advantages are made apparent to those skilled in the art by referencing the accompanying drawings. The use of the same reference symbols in different drawings indicates similar or identical items.

FIG. 1 is a diagram illustrating an example wireless system employing a channel state feedback (CSF) neural network scheme for characterizing a wireless channel in accordance with some embodiments.

FIG. 2 is a diagram illustrating an example hardware configuration of a user equipment (UE) of the wireless system of FIG. 1 in accordance with some embodiments.

FIG. 3 is a diagram illustrating an example hardware configuration of a base station (BS) of the wireless system of FIG. 1 in accordance with some embodiments.

FIG. 4 is a diagram illustrating an example hardware configuration of a managing infrastructure component of the wireless system of FIG. 1 in accordance with some embodiments.

FIG. 5 is a diagram illustrating a machine learning (ML) module employing a neural network for use in a CSF neural network scheme in accordance with some embodiments.

FIG. 6 is a diagram illustrating a pair of jointly trained neural networks for the processing and transmission of a CSI estimate between a UE and a BS in accordance with some embodiments.

FIG. 7 is a flow diagram illustrating an example method for joint training of a set of neural networks for facilitating CSF in a wireless system in accordance with some embodiments.

FIG. 8 is a flow diagram illustrating an example method for feedback of CSI estimates using a selected and jointly trained set of neural networks in accordance with some embodiments.

FIG. 9 is a ladder signaling diagram illustrating an example operation of the method of FIG. 8 in accordance with some embodiments.

FIG. 10 is a diagram illustrating a selected set of jointly trained neural networks for the transmission of CSI pilot signaling, CSI estimation, and feedback of CSI estimates in accordance with some embodiments.

FIG. 11 is a flow diagram illustrating an example method for determining CSI estimates and feeding back the CSI estimates using neural networks in accordance with some embodiments.

FIG. 12 is a ladder signaling diagram illustrating an example operation of the method of FIG. 11 in accordance with some embodiments.

### DETAILED DESCRIPTION

Channel state feedback (CSF) facilitates various MIMO processes, such as beamforming or space-time coding. To efficiently estimate CSI at a receiving device and provide the CSI estimate as CSF to the transmitting device, in at least one embodiment the transmitting device and receiving device together employ jointly trained neural networks to implement one or more of the pilot transmission process, the CSI estimation process, or the CSI feedback process. This results in a set of neural networks that are trained to, in effect, provide processing equivalent to a conventional sequence of CSF stages without having to be specifically designed and tested for that sequence of CSF stages. To illustrate, in some embodiments the CSI pilot transmission process and CSI estimation process are performed using an algorithmic approach, but the process for providing the CSI estimates back to a transmitting device relies on the use of a jointly trained set of neural networks, including a transmit (TX) neural network at the receiving device that operates to process a CSI estimate for radio frequency (RF) transmission from the receiving device to the transmitting device in a manner that, in effect, efficiently quantizes or compresses the CSI estimate in view of the current wireless channel conditions, and a receive (RX) neural network at the transmitting device that operates to receive and process the wirelessly received output from the TX neural network so as to recover the CSI estimate, or representation thereof, for use by one or more MIMO management processes at the transmitting device.

In another embodiment, neural networks are used for each of the pilot transmission, CSI estimation, and feedback stages. In this approach, the transmitting device employs a TX neural network that operates to generate CSI pilot output that is wirelessly transmitted to a receiving device, which in turn employs an RX neural network to receive the CSI pilot as input and generate a corresponding CSI output representative of a CSI estimate. The receiving device further employs a TX neural network to receive the CSI estimate and generate a CSF output that is representative of a quantized or otherwise compressed version of the CSI estimate. The receiving device transmits this CSF output to the transmitting device, where an RX neural network receives and processes the CSF output to generate a corresponding CSI estimate that the transmitting device then can utilize in managing one or more MIMO processes at the transmitting device.

In either approach, the wireless system can employ joint training of multiple candidate neural network architectural configurations for the various neural networks employed among the transmitting device and the receiving device based on any of a variety of parameters, such as the particular carrier frequency or channel being employed, the signal formatting or protocol, the propagation environment (as characterized by, for example, sensor data from various sensors), compute resources, sensor resources, power resources, antenna resources, and other capabilities. Thus, the particular neural network configuration employed at each of the transmitting device and the receiving device may be selected based on correlations between the particular configuration of these devices and the parameters used to train corresponding neural network architectural configurations.

These techniques and others are described below with reference to a “transmitting device” and a “receiving device.” As used herein, “transmitting device” references the device that acts as the primary transmitter for a corresponding channel link, and “receiving device” references the device that acts as the primary receiver for the corresponding channel link. However, this is not to imply that a transmitting device cannot also receive RF signals via the channel or that a receiving device cannot also transmit RF signals via the channel. For example, in the CSF context, the transmitting device is the device that transmits some form of CSI pilot signaling and the receiving device is the device that receives the CSI pilot signaling and determines some form of CSI or CSI estimate from the CSI signaling for the channel. However, this same receiving device then typically transmits a representation of the determined CSI back to the transmitting device in the same channel or a different channel, in which case the receiving device operates as a transmitter for transmission of the CSI feedback and the transmitting device operates as a receiver for receipt of the transmitted CSI feedback. Moreover, it should be appreciated that a device may operate as a transmitting device for one channel while operating as a receiving device for another channel. For example, a first device may operate as the transmitting device and a second device may operate as a receiving device for channel characterization for a first channel between the first device and the second device (e.g., a downlink channel), and concurrently or at a different time the first device may operate as the receiving device and the second device may operate as the transmitting device for channel characterization for a second channel between the first device and the second device (e.g., an uplink channel) or for a second channel between the second device and a third device (e.g., a sidelink channel).

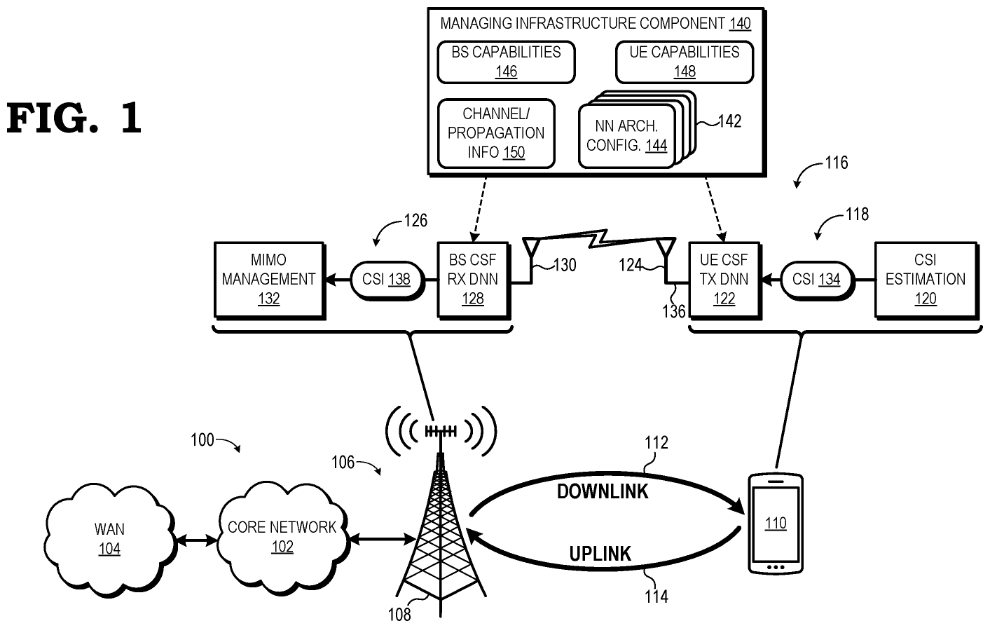

FIG. 1 illustrates a wireless communications system 100 employing neural-network-facilitated channel state feedback in accordance with some embodiments. As depicted, the wireless communication system 100 is a cellular network including a core network 102 coupled to one or more wide area networks (WANs) 104 or other packet data networks (PDNs), such as the Internet. The wireless communications system 100 further includes at least one base station (BS) 108, with each BS 108 supporting wireless communication with one or more UEs, such as UE 110, via RF signaling using one or more applicable radio access technologies (RATs) as specified by one or more communications protocols or standards. As such, the BS 108 operates as the wireless interface between the UE 110 and various networks and services provided by the core network 102 and other networks, such as packet-switched (PS) data services, circuit-switched (CS) services, and the like. Conventionally, communication of data or signaling from the BS 108 to the UE 110 is referred to as “downlink” or “DL” whereas communication of data or signaling from the UE 110 to the BS 108 is referred to as “uplink” or “UL.”

The BS 108 can employ any of a variety of RATs, such as operating as a NodeB (or base transceiver station (BTS)) for a Universal Mobile Telecommunications System (UMTS) RAT (also known as “3G”), operating as an enhanced NodeB (eNodeB) for a Third Generation Partnership Project (3GPP) Long Term Evolution (LTE) RAT, operating as a 5G node B (“gNB”) for a 3GPP Fifth Generation (5G) New Radio (NR) RAT, and the like. The UE 110, in turn, can implement any of a variety of electronic devices operable to communicate with the BS 108 via a suitable RAT, including, for example, a mobile cellular phone, a cellular-enabled tablet computer or laptop computer, a desktop computer, a cellular-enabled video game system, a server, a cellular-enabled appliance, a cellular-enabled automotive communications system, a cellular-enabled smartwatch or other wearable device, and the like.

Communication of information over an air interface formed between the BS 108 and the UE 110 takes the form of RF signals that represent both control plane signaling and user data plane signaling. However, due to one or more of: relatively high frequencies, relatively tight timing margins, relative movement between the transmitting device and receiving device, and the presence or movement of buildings, bodies, and other interfering objects, as well as proximate transmitting interferers, the propagation environment for the channel containing the RF signaling frequently changes. Accordingly, in at least one embodiment, the BS 108 and the UE 110 implement transmitter (TX) and receiver (RX) processing paths that integrate one or more neural networks (NNs) that are trained or otherwise configured to facilitate one or both of the estimation of CSI or the feedback of CSI estimate information from the receiving device to the transmitting device. This confirmation and its associated processes, as described herein, can be implemented for a downlink channel 112 for RF signaling transmitted by the BS 108 for receipt by the UE 110, for an uplink channel 114 for RF signaling transmitted by the UE 110 for receipt by the BS 108, or for each channel 112, 114. Thus, for the downlink channel 112, the BS 108 acts as the transmitting device and the UE 110 acts as the receiving device for CSF purposes, while for the uplink channel 114 the UE 110 acts as the transmitting device and the BS 108 acts as the receiving device for CSF purposes.

To illustrate with respect to a CSF path 116 for the downlink channel 112, the UE 110 employs a TX processing path 118 having a CSI estimation component 120 and a UE CSF TX DNN 122 (or other neural network) having an output coupled to an RF front end 124 of the UE 110. The BS 108 employs an RX processing path 126 having a BS CSF RX DNN 128 (or other neural network) having an input coupled to an RF front end 130 of the BS 108 and a MIMO management component 132 having an input coupled to an output of the BS CSF RX DNN 128.

In operation, the BS 108 transmits, via the RF front end 130, RF signals representative of CSI pilot signals (also commonly referred to as “training signals”) (not shown), which are received by the RF front end 124 of the UE 110 and processed by the CSI estimation component 120 to generate one or more CSI estimates 134 for each frequency or subcarrier represented by the received CSI pilot signals. The CSI estimation component 120 can use any of a variety of well-known or proprietary techniques to generate at least one CSI estimate 134 from a corresponding set of one or more CSI pilot signals transmitted by the BS 108. For example, if the channel and noise distributions are unknown, then the CSI estimation component 120 can use, for example, any of a variety of least-square estimators to determine the CSI estimate 134, whereas if the channel and noise distributions are known, then the CSI estimation component 120 can use, for example, any of a variety of Bayesian estimation techniques to determine the CSI estimate 134. Although the CSI estimate 134 can take on any of a variety of forms or representations as known in the art, for ease of reference, an implementation of the CSI estimate 134 as a set of one or more matrices, with each matrix representing a corresponding transfer form for a corresponding carrier frequency. However, it will be appreciated that the CSI estimate 134 is not limited to this particular implementation, and may represent any of a variety of suitable CSI estimate forms.

The CSI estimate 134 is provided as an input to the UE CSF TX DNN 122, along with any of a variety of optional other inputs, such as sensor data input indicating the current propagation environment as observed by one or more sensors of the UE 110 (and as described below). The UE CSF TX DNN 122, in at least one embodiment, is jointly trained along with the BS CSF RX DNN 128 of the BS 108, and thus produces a CSF output from the CSI estimate 134 (and any other inputs) that are suited for RF transmission to the BS 108 and for processing by the BS CSF RX DNN 128. As part of this joint training or other configuration, the UE CSF TX DNN 122 is, in at least one embodiment, trained or configured to, in effect, quantize or otherwise compress the data or information represented by the CSI estimate 134 and otherwise process the resulting compressed information in view of input sensor data or other input to generate a CSF output 136 that is provided to the RF front end 124 for wireless transmission to the BS 108.

At the BS 108, the RF front end 130 extracts the CSF output 136 from the received RF signaling and provides the CSF output 136 as an input to the BS CSF RX DNN 128. Optional other inputs, such as sensor data from sensors of the BS 108, also may be concurrently provided as inputs to the BS CSF RX DNN 128. From these inputs, and based on the joint training or other configuration, the BS CSF RX DNN 128 operates to provide a recovered representation of the CSI estimate 134, referred to herein as recovered CSI estimate 138. The recovered CSI estimate 138 then is provided to the MIMO management component 132, which uses the recovered CSI estimate 138 to control one or more MIMO processes of the BS 108 relative to the downlink channel 112 with the UE 110, such as by controlling one or more of a beamforming process, a space-time coding process, or a multiple-user MIMO process utilized by the RF front end 130 for RF transmissions to at least the UE 110.

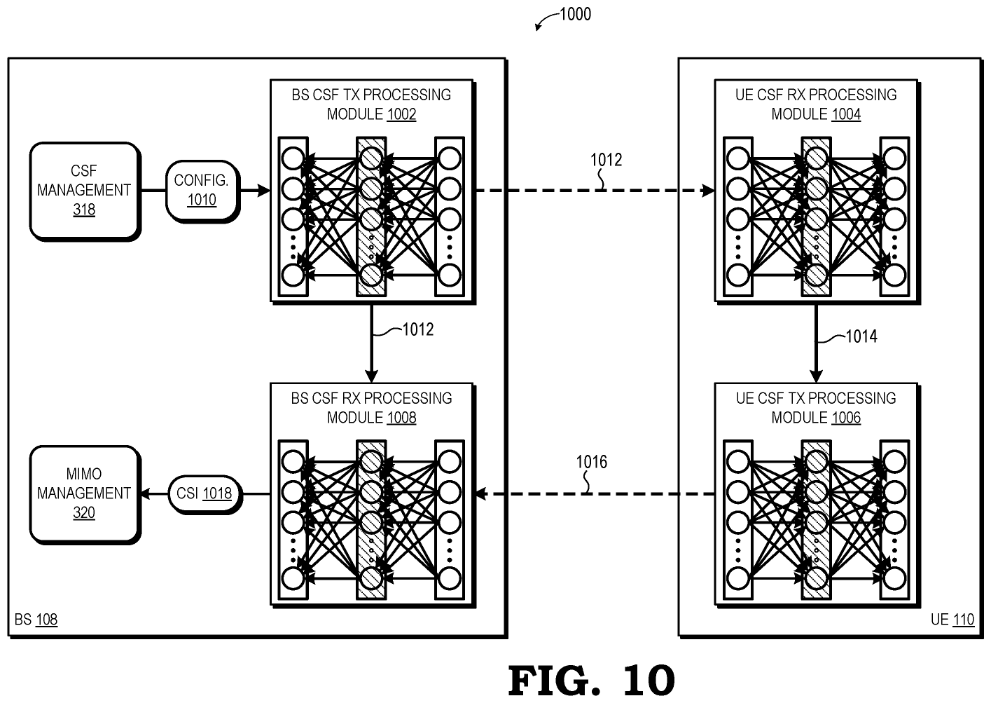

Although FIG. 1 illustrates a CSF path 116 for the downlink channel 112, it will be appreciated that a configuration similar to that illustrated also can be utilized for providing a CSF path for the uplink channel 114, with the BS 108 employing a similar CSI estimation component and CSF TX DNN and the UE 110 employing a similar CSF RX DNN and a MIMO management component. However, for ease of illustration the neural-network-based CSF techniques of the present disclosure are described in the example context of a downlink channel from BS to UE, but it will be appreciated that these same techniques are equally applicable to an uplink channel from UE to BS, or between any RF-enabled device operating as a transmitting device and another RF-enabled device operating as a receiving device for CSF purposes. Moreover, while FIG. 1 illustrates an example implementation in which the generation and transmission of CSI pilot signals by the transmitting device and the algorithmic estimation of CSI based on the received CSI pilot signals at the receiving device may be performed using conventional approaches, in other embodiments, one or more of these processes may be partially or fully implemented using jointly trained neural networks as well, as described subsequently with reference to FIGS. 10-12.

As noted above and described in greater detail herein, both the transmitting device and the receiving device (e.g., the BS 108 and the UE 110, respectively, for the CSF path 116) employ one or more DNNs or other neural networks that are jointly trained and selected based on context-specific parameters so as to facilitate the overall CSF process. To manage the joint training, selection, and maintenance of these neural networks, in at least one embodiment the system 100 further includes a managing infrastructure component 140 (or “managing component 140” for purposes of brevity). This managing component 140 can include, for example, a server or other component within a network infrastructure 106 of the wireless communication system 100, such as within the core network 102 or a WAN 104. Further, although depicted in the illustrated example as a separate component, in at least some embodiments the BS 108 implements the managing component 140. The oversight functions provided by the managing component 140 can include, for example, some or all of overseeing the joint training of the neural networks, managing the selection of a particular neural network architecture configuration for one or more of the transmitting device or the receiving device based on their specific capabilities or other component-specific parameters, receiving and processing capability updates for purposes of neural network configuration selection, receiving and processing feedback for purposes of neural network training or selection, and the like.

As described below in more detail, the managing component 140, in some embodiments, maintains a set 142 of candidate neural network architectural configurations 144 that may be selected to be employed at a particular component in the corresponding CSF path based at least in part on the current capabilities of the component implementing the corresponding neural network, the current capabilities of other components in the transmission chain, or a combination thereof. These capabilities can include, for example, sensor capabilities, processing resource capabilities, battery/power capabilities, RF antenna capabilities, capabilities of one or more accessories of the component, the type(s) or nature of the data to be transmitted via the corresponding channel, and the like. The information representing these capabilities for the BS 108 and the UE 110 is obtained by, and stored at, the managing component 140 as BS capability information 146 and UE capability information 148, respectively. The managing component 140 further may consider parameters or other aspects of the corresponding channel or the propagation channel of the environment, such as the carrier frequency of the channel, the known presence of objects or other interferers, and the like. The information representing the aspects of the channel or the propagating environment is obtained by, and stored at, the managing component 140 as channel/propagation information 150.

In support of this approach, in some embodiments, the managing component 140 can manage the joint training of different combinations of candidate neural network architectural configurations 144 for different capability/context combinations. The managing component 140 then can obtain capability information 146 from the BS 108, capability information 148 from the UE 110, or both, and from this capability information, the managing component 140 selects neural network architectural configurations from the set 142 of candidate neural network architectural configurations 144 for each component at least based in part on the corresponding indicated capabilities and RF signaling environment reflected in channel/propagation information 150. In some embodiments, the candidate neural network architectural configurations are jointly trained as paired subsets, such that each candidate neural network architectural configuration for a particular capability set for the BS 108 is jointly trained with a single corresponding candidate neural network architectural configuration for a particular capability set for the UE 110. In other embodiments, the candidate neural network architectural configurations are trained such that each candidate configuration for the BS 108 has a one-to-many correspondence with multiple candidate configurations for the UE 110, and vice versa.

Thus, the system 100 utilizes a CSF approach that relies on a managed, jointly trained, and selectively-employed set of neural networks between transmitting devices and receiving devices for CSI feedback, rather than independently-designed process blocks that may not have been specifically designed for compatibility. Not only does this provide for improved flexibility, but in some circumstances can provide for more rapid processing at each device, as well as more efficient RF transmission, and thus decrease the latency in estimating, communicating, and implementing CSI estimates. This in turn facilitates finer-grained and more timely control of MIMO processes for more efficient and effective signaling between the transmitting device and the receiving device.

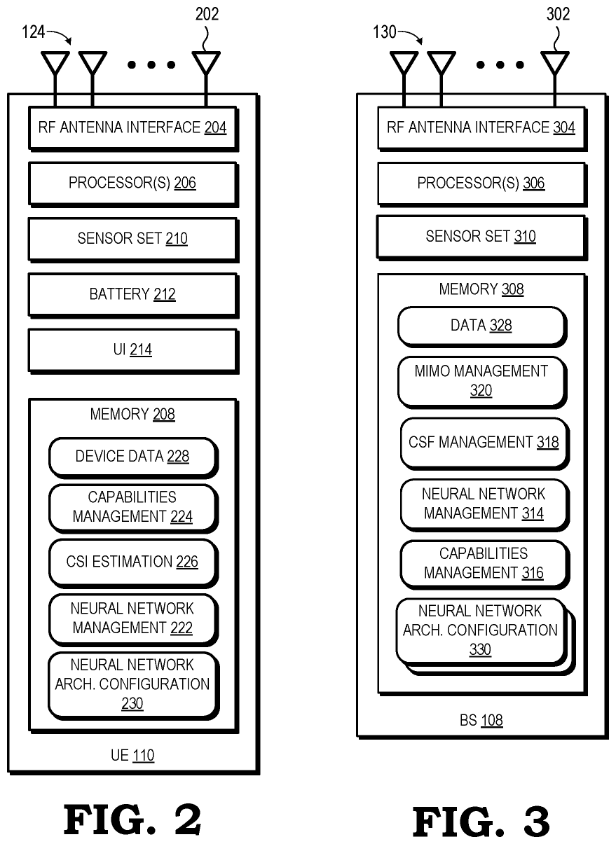

FIG. 2 illustrates example hardware configurations for the UE 110 (as representative receiving device) in accordance with some embodiments. Note that the depicted hardware configuration represents the processing components and communication components most directly related to the neural network-based processes described herein and omit certain components well-understood to be frequently implemented in such electronic devices, such as displays, non-sensor peripherals, external power supplies, and the like.

In the depicted configuration, the UE 110 includes the RF front end 124 having one or more antennas 202 and an RF antenna interface 204 having one or more modems to support one or more RATs. The RF front end 124 operates, in effect, as a physical (PHY) transceiver interface to conduct and process signaling between one or more processors 206 of the UE 110 and the antennas 202 so as to facilitate various types of wireless communication. The antennas 202 can be arranged in one or more arrays of multiple antennas that are configured similar to or different from each other and can be tuned to one or more frequency bands associated with a corresponding RAT. The one or more processors 206 can include, for example, one or more central processing units (CPUs), graphics processing units (GPUs), tensor processing units (TPUs) or other application-specific integrated circuits (ASIC), and the like. To illustrate, the processors 206 can include an application processor (AP) utilized by the UE 110 to execute an operating system and various user-level software applications, as well as one or more processors utilized by modems or a baseband processor of the RF front end 124. The UE 110 further includes one or more computer-readable media 208 that include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the computer-readable media 208 is referred to herein as “memory 208” in view of frequent use of system memory or other memory to store data and instructions for execution by the processor 206, but it will be understood that reference to “memory 208” shall apply equally to other types of storage media unless otherwise noted.

In at least one embodiment, the UE 110 further includes a plurality of sensors, referred to herein as sensor set 210, at least some of which are utilized in the neural-network-based schemes described herein. Generally, the sensors of the sensor set 210 include those sensors that sense some aspect of the environment of the UE 110 or the use of the UE 110 by a user which have the potential to sense a parameter that has at least some impact on, or is a reflection of, an RF propagation path of, or RF transmission/reception performance by, the UE 110 relative to the BS 108. The sensors of the sensor set 210 can include one or more sensors for object detection, such as radar sensors, lidar sensors, imaging sensors, structured-light-based depth sensors, and the like. The sensor set 210 also can include one or more sensors for determining a position or pose of the UE 110, such as satellite positioning sensors such as GPS sensors, Global Navigation Satellite System (GNSS) sensors, internal measurement unit (IMU) sensors, visual odometry sensors, gyroscopes, tilt sensors or other inclinometers, ultrawideband (UWB)-based sensors, and the like. Other examples of types of sensors of the sensor set 210 can include imaging sensors, such as cameras for image capture by a user, cameras for facial detection, cameras for stereoscopy or visual odometry, light sensors for detection of objects in proximity to a feature of the device, and the like. The UE 110 further can include one or more batteries 212 or other portable power sources, as well as one or more user interface (UI) components 214, such as touch screens, user-manipulable input/output devices (e.g., “buttons” or keyboards), or other touch/contact sensors, microphones, or other voice sensors for capturing audio content, image sensors for capturing video content, thermal sensors (such as for detecting proximity to a user), and the like.

The one or more memories 208 of the UE 110 are used to store one or more sets of executable software instructions and associated data that manipulate the one or more processors 206 and other components of the UE 110 to perform the various functions described herein and attributed to the UE 110. The sets of executable software instructions include, for example, an operating system (OS) and various drivers (not shown), and various software applications. The sets of executable software instructions further include one or more of a neural network management module 222, a capabilities management module 224, or a CSI estimation module 226 (one embodiment of the CSI estimation component 120, FIG. 1). The neural network management module 222 implements one or more neural networks for the UE 110, as described in detail below. The capabilities management module 224 determines various capabilities of the UE 110 that may pertain to neural network configuration or selection and reports such capabilities to the managing component 140, as well as monitors the UE 110 for changes in such capabilities, including changes in RF and processing capabilities, changes in accessory availability or capability, and the like, and manages the reporting of such capabilities, and changes in the capabilities, to the managing component 140. As similarly described above, the CSI estimation module 226 operates to generate CSI estimates based on received representations of CSI pilot signals transmitted by another device, such as the BS 108. In at least one embodiment, the CSI estimation module 226 implements one or more algorithmic techniques for calculating CSI estimates, such as any of a variety of least squares (LS), least mean squares (LMS), or Bayesian CSI estimation techniques as known in the art.

To facilitate the operations of the UE 110 as described herein, the one or more memories 208 of the UE 110 further can store data associated with these operations. This data can include, for example, device data 228 and one or more neural network architecture configurations 230. The device data 228 represents, for example, user data, multimedia data, beamforming codebooks, software application configuration information, and the like. The device data 228 further can include capability information for the UE 110, such as sensor capability information regarding the one or more sensors of the sensor set 210, including the presence or absence of a particular sensor or sensor type, and, for those sensors present, one or more representations of their corresponding capabilities, such as range and resolution for lidar or radar sensors, image resolution and color depth for imaging cameras, and the like. The capability information further can include information regarding, for example, the capabilities or status of the battery 212, the capabilities or status of the UI 214 (e.g., screen resolution, color gamut, or frame rate for a display), and the like.

The one or more neural network architecture configurations 230 represent UE-implemented examples selected from the set 142 of candidate neural network architectural configurations 144 maintained by the managing component 140. Each neural network architecture configuration 230 includes one or more data structures containing data and other information representative of a corresponding architecture and/or parameter configurations used by the neural network management module 222 to form a corresponding neural network of the UE 110. The information included in a neural network architectural configuration 230 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configuration 230 includes any combination of NN formation configuration elements (e.g., architecture and/or parameter configurations) that can be used to create a NN formation configuration (e.g., a combination of one or more NN formation configuration elements) that defines and/or forms a DNN.

FIG. 3 illustrates example hardware configurations for the BS 108 (as representative transmitting device) in accordance with some embodiments. Note that the depicted hardware configuration represents the processing components and communication components most directly related to the neural network-based processes described herein and omit certain components well-understood to be frequently implemented in such electronic devices, such as displays, non-sensor peripherals, external power supplies, and the like. Further note that although the illustrated diagram represents an implementation of the BS 108 as a single network node (e.g., a 5G NR Node B, or “gNB”), the functionality, and thus the hardware components, of the BS 108 instead may be distributed across multiple network nodes or devices and may be distributed in a manner to perform the functions described herein.

In the depicted configuration, the BS 108 includes the RF front end 130 having one or more antennas 302 and an RF antenna interface 304 having one or more modems to support one or more RATs, and which operates as a PHY transceiver interface to conduct and process signaling between one or more processors 306 of the BS 108 and the antennas 302 so as to facilitate various types of wireless communication. The antennas 302 can be arranged in one or more arrays of multiple antennas that are configured similar to or different from each other and can be tuned to one or more frequency bands associated with a corresponding RAT. The one or more processors 306 can include, for example, one or more CPUs, GPUs, TPUs or other ASICs, and the like. The BS 108 further includes one or more computer-readable media 308 that include any of a variety of media used by electronic devices to store data and/or executable instructions, such as RAM, ROM, caches, Flash memory, SSD or other mass-storage devices, and the like. As with the memory 208 of the UE 110, for ease of illustration and brevity, the computer-readable media 308 is referred to herein as “memory 308” in view of frequent use of system memory or other memory to store data and instructions for execution by the processor 306, but it will be understood that reference to “memory 308” shall apply equally to other types of storage media unless otherwise noted.

In at least one embodiment, the BS 108 further includes a plurality of sensors, referred to herein as sensor set 310, at least some of which are utilized in the neural-network-based schemes described herein. Generally, the sensors of the sensor set 310 include those sensors that sense some aspect of the environment of the BS 108 and which have the potential to sense a parameter that has at least some impact on, or is a reflection of, an RF propagation path of, or RF transmission/reception performance by, the BS 108 relative to the corresponding UE 110. The sensors of the sensor set 310 can include one or more sensors for object detection, such as radar sensors, lidar sensors, imaging sensors, structured-light-based depth sensors, and the like. In the event that the BS 108 is a mobile BS, the sensor set 310 also can include one or more sensors for determining a position or pose of the BS 108. Other examples of types of sensors of the sensor set 310 can include imaging sensors, light sensors for detection of objects in proximity to a feature of the BS 108, and the like.

The one or more memories 308 of the BS 108 are used to store one or more sets of executable software instructions and associated data that manipulate the one or more processors 306 and other components of the BS 108 to perform the various functions described herein and attributed to the BS 108. The sets of executable software instructions include, for example, an operating system (OS) and various drivers (not shown), and various software applications. The sets of executable software instructions further include one or more of a neural network management module 314, a capabilities management module 316, a CSF management module 318, or a MIMO management module 320.

The neural network management module 314 implements one or more neural networks for the BS 108, as described in detail below. The capabilities management module 318 determines various capabilities of the BS 108 that may pertain to neural network configuration or selection and reports such capabilities to the managing component 140, as well as monitors the BS 108 for changes in such capabilities, including changes in RF and processing capabilities, and the like, and manages the reporting of such capabilities, and changes in the capabilities, to the managing component 140. The CSF management module 318 operates to manage the CSF process between the BS 108 and one or more corresponding Ues 110, including managing the generation and transmission of CSI pilot signals to a corresponding UE 110, obtaining and processing the resulting CSI estimate information as reported by the UE 110 from analysis of the transmitted CSI pilot signals, and communicating representations of the resulting CSI estimates to the MIMO management module 320. The MIMO management module 320, in turn, operates to control one or more MIMO processes of the RF front end 124 based on the supplied CSI estimates. These MIMO processes can include beamforming processes, space-time coding processes, MU-MIMO processes, and the like.

To facilitate the operations of the BS 108 as described herein, the one or more memories 308 of the BS 108 further can store data associated with these operations. This data can include, for example, BS data 328 and one or more neural network architecture configurations 330. The BS data 328 represents, for example, beamforming codebooks, software application configuration information, and the like. The BS data 328 further can include capability information for the BS 108, such as sensor capability information regarding the one or more sensors of the sensor set 310, including the presence or absence of a particular sensor or sensor type, and, for those sensors present, one or more representations of their corresponding capabilities, such as range and resolution for lidar or radar sensors, image resolution and color depth for imaging cameras, and the like. The one or more neural network architecture configurations 330 represent BS-implemented examples selected from the set 142 of candidate neural network architectural configurations 144 maintained by the managing component 140. Thus, as with the neural network architectural configurations 230 of FIG. 2, each neural network architecture configuration 330 includes one or more data structures containing data and other information representative of a corresponding architecture and/or parameter configurations used by the neural network management module 314 to form a corresponding neural network of the BS 108.

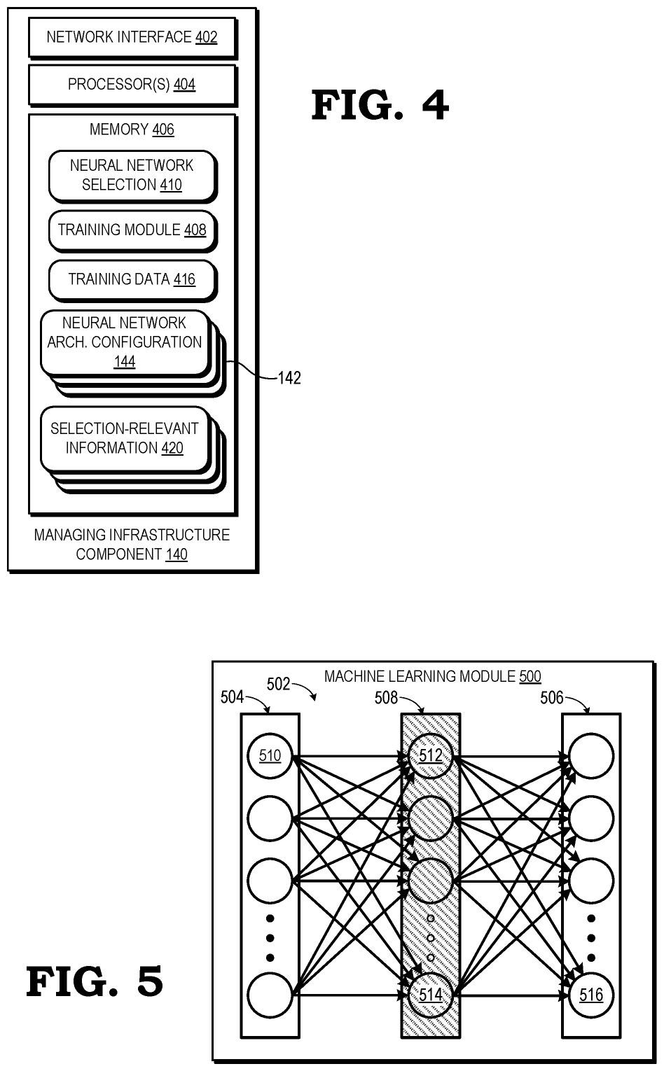

FIG. 4 illustrates an example hardware configuration for the managing component 140 in accordance with some embodiments. Note that the depicted hardware configuration represents the processing components and communication components most directly related to the neural network-based processes described herein and omit certain components well-understood to be frequently implemented in such electronic devices. Further, although the hardware configuration is depicted as being located at a single component, the functionality, and thus the hardware components, of the managing component 140 instead may be distributed across multiple infrastructure components or nodes and may be distributed in a manner to perform the functions described herein.

As noted above, the managing component 140 can be implemented at any of a variety of components, or combination of components, within the network infrastructure 106. For ease of illustration, the managing component 140 is described herein with reference to an example implementation as a server or other component in one of the core networks 102, but in other embodiments the managing component 140 may be implemented as, for example, part of the BS 108.

As shown, the managing component 140 includes one or more network interfaces 402 (e.g., an Ethernet interface) to couple to one or more networks of the system 100, one or more processors 404 coupled to the one or more network interfaces 402, and one or more non-transitory computer-readable storage media 406 (referred to herein as a “memory 406” for brevity) coupled to the one or more processors 404. The one or more memories 406 stores one or more sets of executable software instructions and associated data that manipulate the one or more processors 404 and other components of the managing component 140 to perform the various functions described herein and attributed to the managing component 140. The sets of executable software instructions include, for example, an OS and various drivers (not shown). The software stored in the one or more memories 406 further can include one or more of a training module 408 or a neural network selection module 410. The training module 408 operates to manage the joint training of candidate neural network architectural configurations 144 for the set 142 of candidate neural networks available to be employed at the transmitting and receiving devices in a CSF path using one or more sets of training data 416. The training can include training neural networks while offline (that is, while not actively engaged in processing the communications) and/or online (that is, while actively engaged in processing the communications). Moreover, the training may be individual or separate, such that each neural network is individually trained on its own training data set without the result being communicated to, or otherwise influencing, the DNN training at the opposite end of the transmission path, or the training may be joint training, such that the neural networks in a data stream transmission path are jointly trained on the same, or complementary, data sets.

The neural network selection module 410 operates to obtain, filter, and otherwise process selection-relevant information 420 from one or both of the transmitting device and the receiving device in a CSF path, such as the BS 108 and UE 110, respectively, for the example CSF path 116 of FIG. 1, and using this selection-relevant information 420 select a pair of jointly trained neural network architectural configurations 144 from candidate set 142 for implementation at the transmitting device and the receiving device in the CSF path. As noted above, this selection-relevant information 420 can include, for example, current capability information from one or both of the UE 110 and the BS 108, current propagation path information, channel-specific parameters, and the like. After a selection has been made, the neural network selection module 410 then initiates the transmission of an indication of the neural network architectural configuration 144 selected for each network component, such as via transmission of an index number associated with the selected configuration, transmission of one or more data structures representative of the neural network architectural configuration itself, or a combination thereof.

FIG. 5 illustrates an example machine learning (ML) module 500 for implementing a neural network in accordance with some embodiments. As described herein, one or both of the transmitting device and the receiving device in a CSF path (e.g., the BS 108 and UE 110, respectively, in the CSF path 116 of FIG. 1) implements one or more DNNs or other neural networks in for processing incoming or outgoing wireless communications associated with CSI feedback. The ML module 500 therefore illustrates an example module for implementing one or more of these neural networks.

In the depicted example, the ML module 500 implements at least one deep neural network (DNN) 502 with groups of connected nodes (e.g., neurons and/or perceptrons) that are organized into three or more layers. The nodes between layers are configurable in a variety of ways, such as a partially-connected configuration where a first subset of nodes in a first layer are connected with a second subset of nodes in a second layer, a fully-connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based upon adaptive learning. Using the DNN 502, the ML module 500 performs a variety of different types of analysis, including single linear regression, multiple linear regression, logistic regression, step-wise regression, binary classification, multiclass classification, multivariate adaptive regression splines, locally estimated scatterplot smoothing, and so forth.

In some implementations, the ML module 500 adaptively learns based on supervised learning. In supervised learning, the ML module 500 receives various types of input data as training data. The ML module 500 processes the training data to learn how to map the input to a desired output. As one example, the ML module 500 receives digital samples of a signal as input data and learns how to map the signal samples to binary data that reflects information embedded within the signal. As another example, the ML module 500 receives binary data as input data and learns how to map the binary data to digital samples of a signal with the binary data embedded within the signal. Still further, as another example and as described in greater detail below, when used in a TX mode, the ML module 500 receives an outgoing information block and learns both how to generate an output that, in effect, represents a data encoded (e.g., compressed) and channel encoded represented in the information block so as to form an output suitable for wireless transmission by an RF antenna interface. Conversely, the ML module 500, when implemented in an RX mode, can be trained to receive an input that represents, in effect, a data encoded and channel encoded representation of an information block, and process the input to generate an output that is, in effect, a data decoded and channel decoded representation of the input, and thus represents a recovered representation of the data of the information. As described further below, the training in either or both of the TX mode or the RX mode further can include training using sensor data as input, capability information as input, accessory information as input, RF antenna configuration, or other operational parameter information as input, and the like.

During a training procedure, the ML module 500 uses labeled or known data as an input to the DNN 502. The DNN 502 analyzes the input using the nodes and generates a corresponding output. The ML module 500 compares the corresponding output to truth data and adapts the algorithms implemented by the nodes to improve the accuracy of the output data. Afterward, the DNN 502 applies the adapted algorithms to unlabeled input data to generate corresponding output data. The ML module 500 uses one or both of statistical analysis and adaptive learning to map an input to an output. For instance, the ML module 500 uses characteristics learned from training data to correlate an unknown input to an output that is statistically likely within a threshold range or value. This allows the ML module 500 to receive complex input and identify a corresponding output. As noted, some implementations train the ML module 500 on characteristics of communications transmitted over a wireless communication system (e.g., time/frequency interleaving, time/frequency deinterleaving, convolutional encoding, convolutional decoding, power levels, channel equalization, inter-symbol interference, quadrature amplitude modulation/demodulation, frequency-division multiplexing/de-multiplexing, transmission channel characteristics) concurrent with characteristics of data encoding/decoding schemes employed in such systems. This allows the trained ML module 500 to receive samples of a signal as an input and recover information from the signal, such as the binary data embedded in the signal.

In the depicted example, the DNN 502 includes an input layer 504, an output layer 506, and one or more hidden layers 508 positioned between the input layer 504 and the output layer 506. Each layer has an arbitrary number of nodes, where the number of nodes between layers can be the same or different. That is, the input layer 504 can have the same number and/or a different number of nodes as output layer 506, the output layer 506 can have the same number and/or a different number of nodes than the one or more hidden layer 508, and so forth.

Node 510 corresponds to one of several nodes included in input layer 504, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. Each node can, in some cases, determine whether to pass the processed input data to one or more next nodes. To illustrate, after processing input data, node 510 can determine whether to pass the processed input data to one or both of node 512 and node 514 of hidden layer 508. Alternatively or additionally, node 510 passes the processed input data to nodes based upon a layer connection architecture. This process can repeat throughout multiple layers until the DNN 502 generates an output using the nodes (e.g., node 516) of output layer 506.

A neural network can also employ a variety of architectures that determine what nodes within the neural network are connected, how data is advanced and/or retained in the neural network, what weights and coefficients are used to process the input data, how the data is processed, and so forth. These various factors collectively describe a neural network architecture configuration, such as the neural network architecture configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration can include a variety of parameter configurations that influence how the DNN 502 or other neural network processes input data.

A neural network architecture configuration of a neural network can be characterized by various architecture and/or parameter configurations. To illustrate, consider an example in which the DNN 502 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer, and use the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In some implementations, the weights and biases are learned parameter configurations, such as parameter configurations generated from training data. A layer parameter specifies layer connections and/or layer types, such as a fully-connected layer type that indicates to connect every node in a first layer (e.g., output layer 506) to every node in a second layer (e.g., hidden layer 508), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that can be applied to a DNN that influences how the DNN processes input data to generate output data.

In some embodiments, the configuration of the ML module 500 is further based on a current operating environment. To illustrate, consider an ML module trained to generate binary data from digital samples of a signal. An RF signal propagation environment oftentimes modifies the characteristics of a signal traveling through the physical environment. RF signal propagation environments oftentimes change, which impacts how the environment modifies the signal. A first RF signal propagation environment, for instance, modifies a signal in a first manner, while a second RF signal propagation environment modifies the signal in a different manner than the first. These differences impact the accuracy of the output results generated by the ML module 500. For instance, the DNN 502 configured to process communications transmitted in the first RF signal propagation environment may generate errors or otherwise limit performance when processing communications transmitted in the second RF signal propagation environment. Certain sensors of the sensor set of the component implementing the DNN 502 may provide sensor data that represents one or more aspects of the current RF signal propagation environment. Examples noted above can include lidar, radar, or other object-detecting sensors to determine the presence or absence of interfering objects within a LOS propagation path, UI sensors to determine the presence and/or position of a user's body relative to the component, and the like. However, it will be appreciated that the particular sensor capabilities available may depend on the particular component implementing the sensors. For example, the BS 108 may have lidar or radar capability, and thus the ability to detect objects in proximity, while the UE 110 may lack lidar and radar capabilities. As another example, a smartphone (one embodiment of the UE 110) may have a light sensor that may be used to sense whether the smartphone is in a user's pocket or bag, while a notebook computer (another embodiment of the UE 110) may lack this capability. As such, in some embodiments, the particular configuration implemented for the ML module 500 may depend at least in part on the particular sensor configuration of the device implementing the ML module 500.

The architectural configuration of the ML module 500 also may be based on capabilities of the node implementing the ML module 500, of one or more nodes upstream or downstream of the node implementing the ML module 500, or a combination thereof. For example, the UE 110 may be battery power limited, and thus the ML modules 500 for both the UE 110 and the BS 108 may be trained based on battery power as an input so as to facilitate, for example, the ML modules 500 at both ends to employ a CSI estimate coding scheme that is better suited to lower power consumption. Further, in some embodiments, the architectural configuration of the ML module 500, when implemented in a TX processing module for CSI feedback, may be based on, or trained for, prediction of the CSI in a future period (a predicted future CSI estimate) when the CSI will be considered for control of one or more MIMO processes, and thus the ML module 500 may be trained to employ such prediction.

Accordingly, in some embodiments, the device implementing the ML module 500 may be configured to implement different neural network architecture configurations for different combinations of capability parameters, RF environment parameters, and the like. For example, a device may have access to one or more neural network architectural configurations for use when an imaging camera is available for use at the device and the other device in the CSF path utilizes lidar, and a different set of one or more neural network architectural configurations for use when the imaging camera is unavailable at the device and the other device utilizes radar.

In some embodiments, the device implementing the ML module 500 locally stores some or all of a set of candidate neural network architectural configurations that can be employed for the ML module 500. For example, the candidate neural network architectural configurations may be indexed by a look-up table (LUT) or other data structure that takes as inputs one or more parameters, such as one or more capability parameters, propagation environment parameters, one or more channel parameters, and the like, and outputs an identifier associated with a corresponding locally-stored candidate neural network architectural configuration that is suited for operation in view of the input parameter(s). However, in some embodiments the neural network employed at the transmitting device and the neural network employed at the receiving device are jointly trained, and thus a mechanism may need to be employed between the transmitting device and the receiving device to help ensure that each device selects for its ML module 500 a neural network architectural configuration that has been jointly trained with, or at least is operationally compatible with, the neural network architectural configuration the other device has selected for its complementary ML module 500. This mechanism can include, for example, coordinating signaling transmitted between the two devices directly or via the managing component 140, or the managing component 140 may serve as a referee that selects a compatible jointly trained pair of architectural configurations from a subset proposed by each device.

However, in other embodiments it may be more efficient or otherwise advantageous to have the managing component 140 operate to select the appropriate jointly trained pair of neural network architectural configurations to be employed at the counterpart ML modules 500 at the transmitting device and receiving device. In this approach, the managing component 140 obtains information representing some or all of the parameters that may be used in the selection process from the transmitting and receiving devices, and from this information selects a jointly trained pair of neural network architectural configurations 144 from the set 142 of such configurations maintained at the managing component 140. This selection process may be implemented using, for example, one or more algorithms, a LUT, and the like. The managing component 140 then may transmit to each device either an identifier or other indication of the neural network architectural configuration selected for the ML module 500 of that device (in the event that each device has a locally stored copy) or the managing component 140 may transmit one or more data structures representative of the neural network architectural configuration selected for that device.

To facilitate the process of selecting an appropriate pair of neural network architectural configurations for the transmitting and receiving devices, in at least one embodiment the managing component 140 trains the ML modules 500 in a training CSF path using a suitable combination of the neural network management modules and training modules. The training can occur offline when no active communication exchanges are occurring, or online during active communication exchanges. For example, the managing component 140 can mathematically generate training data, access files that store the training data, obtain real-world communications data, etc. The managing component 140 then extracts and stores the various learned neural network architecture configurations for subsequent use. Some implementations store input characteristics with each neural network architecture configuration, whereby the input characteristics describe various properties of one or both of the RF signal propagation environment and capability configuration corresponding to the respective neural network architecture configurations. In implementations, a neural network manager selects a neural network architecture configuration by matching a current RF signal propagation environment and current operational environment to the input characteristics, with the current operating environment including indications of capabilities of one or more nodes along the training CSF path, such as sensor capabilities, RF capabilities, streaming accessory capabilities, processing capabilities, scheduling latencies, and the like.

As noted, network devices that are in wireless communication, such as BS 108 and the UE 110, can be configured to process wireless communication exchanges using one or more DNNs at each networked device, where each DNN replaces one or more functions conventionally implemented by one or more hard-coded or fixed-design blocks in furtherance of a CSI estimation process or CSF process. Moreover, each DNN can further incorporate current sensor data from one or more sensors of a sensor set of the networked device and or capability data from some or all of the nodes along the chain 116 to, in effect, modify or otherwise adapt its operation to account for the current operational environment.

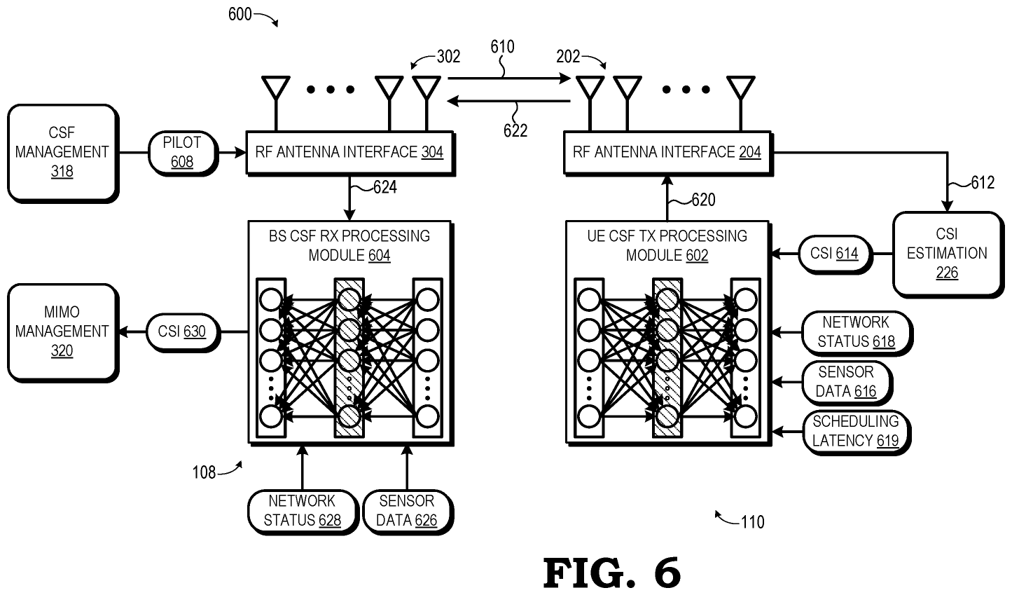

To this end, FIG. 6 illustrates an example operating environment 600 for DNN implementation in the example CSF path 116 of FIG. 1, in which the BS 108 operates as the transmitting device and the UE 110 operates as the receiving device. In the depicted example, the neural network management module 222 of the UE 110 implements a CSF transmitter (TX) processing module 602, while the neural network management module 314 of the BS 108 implements a CSF receiver (RX) processing module 604. In at least one embodiment, each of these processing modules implements one or more DNNs via the implementation of a corresponding ML module, such as described above with reference to the one or more DNNs 502 of the ML module 500 of FIG. 5.

In the illustrated approach, the operating environment 600 utilizes a conventional approach for the process of generating CSI estimates but employs a neural-network based approach for the encoding and transmission of the CSI estimates back to the BS 108. Thus, the CSF management module 318 generates a sequence of one or more CSI pilot signals 608, each of which is provided to the RF antenna interface 304 of the BS 108 for conversion to a corresponding RF signal 610 transmitted via one or more antennas 302 to the UE 110. The RF signal 610 is received and processed at the UE 110 via one or more antenna 202 and the RF antenna interface 204, and the resulting captured signal 612 is analyzed by the CSI estimation module 226 to generate one or more CSI estimates for the antenna/receiver/subcarrier corresponding to the transmitted CSI pilot signal 608. The CSI estimation module 226 may use any of a variety of well-known or proprietary techniques for CSI estimation. In general, such CSI estimation techniques leverage the fact that the parameters of the CSI pilot signal 608 are known a priori, and thus the actual received form of the captured signal 612 can be compared to its expected received form to determine the CSI estimate.

In a conventional CSF process, the CSI estimate for the corresponding antenna/receiver/subcarrier combination would be added to a corresponding index location of a CSI estimate matrix, that when completed, would then be transmitted back from the UE to the BS using some fixed, hardcoded compression algorithm, such as vector quantization (VQ), so as to reduce the total amount of data to be transmitted for the CSI estimate matrix. However, in complex systems, such as massive MIMO systems or MU-MIMO systems, the increased number of antennas, subcarriers, and users results in an exponential increase to the size of the resulting CSI estimate matrix, which can render the traditional hardcoded, algorithmic approach to quantizing or otherwise compressing the CSI estimate matrix for transmission impracticable, or at least excessively complex.

As such, instead of employing a hardcoded or algorithmic CSI estimate quantization process, the CSF TX processing module 602 of the UE 110 and the CSF RX processing module 604 of the BS 108 instead interoperate to support a neural network-based wireless feedback path between the UE 110 and the BS 108 for communicating data representative of CSI estimates determined by the UE 110 from CSI pilot signaling transmitted by the BS 108. To this end, one or more DNNs of the CSF TX processing module 602 of the UE 110 are trained to receive an outgoing CSI estimate data block 614 representative of one or more CSI estimates generated by the CSI estimation module 226 as an input, as well as other inputs, and from these inputs generate a corresponding CSI output 620.

The optional other inputs provided to the CSF TX processing module 602 can include, for example, sensor data 616 from the sensor set 210 and network status information 618 representing current operational parameters for the transmit-side of the RF antenna interface 204, and thus serve as representation of the current RF propagation environment for transmitting the signaling. Further, it will be appreciated that the channel state may change from moment to moment, and thus the latency between when a CSI estimate is generated at the UE 110 and when the MIMO management module 320 uses the CSI estimate to control one or more MIMO processes (referred to herein as “scheduling latency”) may result in out-of-date CSI estimate information from a previous period being used to control MIMO processes in the current period. To compensate for this scheduling latency, the one or more DNNs of the CSF TX processing module 602 may be trained on different scheduling latencies so as to provide a CSI output that is, in effect, a prediction of the future CSI estimate(s) for the next period (as indicated by the scheduling latency of the BS 108) in which the predicted future CSI estimate(s) represented in the CSI output 620 will be used by the MIMO management module 320 of the BS 108. Accordingly, to this end, the UE 110 further may provide as an input to the CSF TX processing module 602 a scheduling latency information 619 representing the scheduling latency for the BS 108, which may be determined through analysis of the operation of the BS 108, determined based on an explicit advertisement of the scheduling by the BS 108, determined based on the scheduling latency of the BS 108 as observed by another UE, and the like.

The RF antenna interface 204 and one or more antennas 202 convert this CSI output 620 into a corresponding RF signal 622 that is wirelessly transmitted for reception by the BS 108. In particular, in some embodiments the one or more DNNs of the CSF TX processing module 602 are trained to provide processing that, in effect, results in a data encoded (e.g., compressed) representation of the input CSI estimate data block 614, with such processing being trained into the one or more DNNs via joint training rather than requiring laborious and inefficient hardcoding of an algorithmic data quantization process. Further, in some embodiments, the one or more DNNs may further operate to provide, in effect, a channel-encoded (including modulation) representation of the CSI estimate data block 614 that is ready for digital-to-analog conversion and RF transmission. That is, rather than employ separate discrete processing blocks to implement a data encoding process followed by an initial RF encoding process, the CSF TX processing module 602 can be trained to concurrently provide the equivalent of such processes and based at least in part on other current data such as the sensor data 616, the network status information 618, and the scheduling latency information 619 to generate a corresponding signal that is, in effect, source encoded and channel encoded and thus ready for RF transmission, and in the case in which scheduling latency is considered, modified to reflect predicted future CSI estimates.

The RF signal 622 propagated from the UE 110 is received and initially processed by the antenna 302 and RF antenna interface 304 of the BS 108. The one or more DNNs of the CSF RX processing module 604 are trained to receive the resulting output of the RF antenna interface 304 as an input 624, optionally along with one or more other inputs, such as sensor data 626 from the sensor set 310 and network status information 628 representing current parameters for the receive-side of the RF antenna interface 304, and the like, and from these inputs, generate a corresponding CSI estimate data block 630 that is a recovered representation, or version, of the CSI estimate data block 614 provided by the CSI estimation module 226 of the UE 110. The processing performed by the CSF RX processing module 604 can include, for example, channel decoding of the input 624 to generate a digital representation of a data encoded version of the CSI estimate data block 614, as well as, in effect, decoding (e.g., decompression) of the data itself to generate a decoded representation of the CSI estimate data block 614. The recovered CSI estimate data block 630 then may be provided to the MIMO management module 320 for use in controlling one or more MIMO-based processes between the BS 108 and the UE 110, or between the BS 108 and multiple UEs. As noted above, such operations can include beamforming operations, spatial diversity operations, and the like.

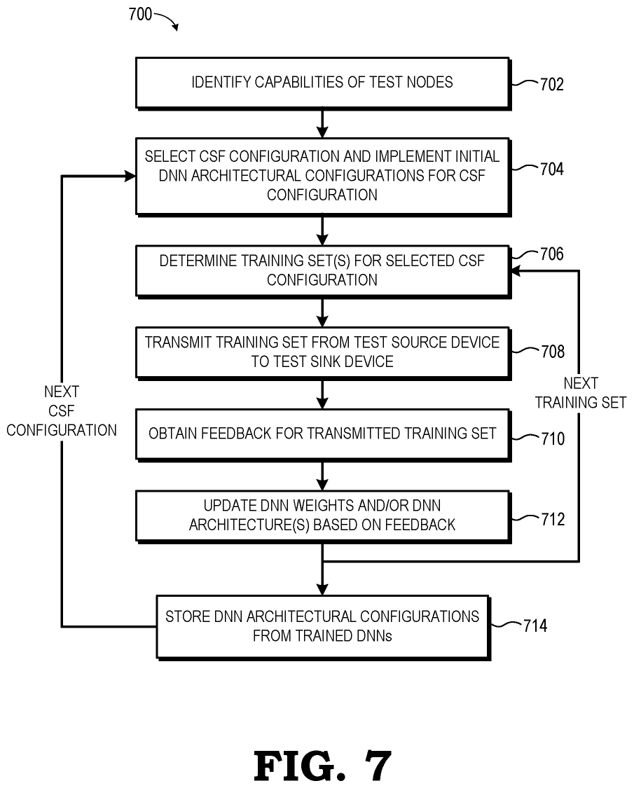

The implementation of jointly trained DNNs or other neural networks for implementing a CSF path between a transmitting device and a receiving device provides flexibility in design and facilitates efficient updates relative to conventional per-block design and test approaches, while also allowing the devices in the CSF path to quickly adapt their processing of outgoing and incoming transmissions to current operational parameters. However, before the DNNs can be deployed and put into operation, they typically are trained or otherwise configured to provide suitable outputs for a given set of one or more inputs. To this end, FIG. 7 illustrates an example method 700 for developing one or more jointly trained DNN architectural configurations as options for the devices in a CSF path for different operating environments in accordance with some embodiments. Note that the order of operations described with reference to FIG. 7 is for illustrative purposes only, and that a different order of operations may be performed, and further that one or more operations may be omitted or one or more additional operations included in the illustrated method. Further note that while FIG. 7 illustrates an offline training approach using one or more test nodes, a similar approach may be implemented for online training using one or more nodes that are in active operation.

As explained above, the operations of DNNs employed at one or both devices in the DNN chain forming a corresponding CSF path may be based on particular capabilities and current operational parameters of the CSF path, such as the operational parameters of the device employing the corresponding DNN, of one or more upstream or downstream devices, or a combination thereof, as well as the RF propagation environment in general. These capabilities and operational parameters can include, for example, the types of sensors used to sense the RF transmission environment of a device, the capabilities of such sensors, the power capacity of one or more devices, the processing capacity of the one or more devices, the RF antenna interface configurations (e.g., number of beams, antenna ports, frequencies supported) of the one or more devices, and the like. Because the described DNNs utilize such information to dictate their operations, it will be appreciated that in many instances the particular DNN configuration implemented at one of the nodes is based on particular capabilities and operational parameters currently employed at that device or at the device on the opposite side of the CSF path; that is, the particular DNN configuration implemented is reflective of capability information and operational parameters currently exhibited by the CSF path implemented by the transmitting and receiving devices.

Accordingly, the method 700 initiates at block 702 with the identification of the anticipated capabilities (including anticipated operational parameters or parameter ranges) of one or more test nodes of a test CSF path, which would include a test transmitting device and a test receiving device. For the following, it is assumed that a training module 408 of the managing component 140 is managing the joint training, and thus the capability information for the test devices is known to the training module 408 (e.g., via a database or other locally stored data structure storing this information). However, because the managing component 140 likely does not have a priori knowledge of the capabilities of any given UE, the test transmitting and receiving devices provide the managing component 140 with an indication of their respective capabilities, such as an indication of the types of sensors available at the test device, an indication of various parameters for these sensors (e.g., imaging resolution and picture data format for an imaging camera, satellite-positioning type and format for a satellite-based position sensor, etc.), accessories available at the device and applicable parameters (e.g., number of audio channels), and the like. For example, the test device can provide this indication of capabilities as part of a UECapabilityInformation Radio Resource Control (RRC) message typically provided by UEs in response to a UECapabilityEnquiry RRC message transmitted by a BS in accordance with at least the 4G LTE and 5G NR specifications. Alternatively, the test UE can provide the indication of sensor capabilities as a separate side-channel or control-channel communication. Further, in some embodiments, the capabilities of the test device may be stored in a local or remote database available to the managing component 140, and thus the managing component 140 can query this database based on some form of an identifier of the test device, such as an International Mobile Subscriber Identity (IMSI) value associated with the test device.

In some embodiments, the training module 408 may attempt to train every CSF configuration permutation. However, in implementations in which the transmitting and receiving devices are likely to have a relatively large number and variety of capabilities and other operational parameters, this effort may be impracticable. Accordingly, at block 704 the training module 408 can select a particular CSF configuration for which to jointly train the DNNs of the test devices from a specified set of candidate CSF configurations. Each candidate CSF configuration thus may represent a particular combination of CSF-relevant parameters, parameter ranges, or combinations thereof. Such parameters or parameter ranges can include sensor capability parameters, processing capability parameters, battery power parameters, RF-signaling parameters, such as number and types of antennas, number and types of subchannels, etc., scheduling latency information, and the like. Such CSF-relevant parameters further can represent the particular type of CSI pilot signals to be used by the transmitting device, the manner in which the receiving device is to calculate the CSI estimates and the format in which the CSI estimates are to be provided as CSF, and the like. With a candidate CSF configuration selected for training, further at block 704 the training module 408 identifies an initial DNN architectural configuration for each of the test transmitting device and the test receiving device and directs the test devices to implement these respective initial DNN architectural configurations, either by providing an identifier associated with the initial DNN architectural configuration to the test device in instances where the test device stores copies of the candidate initial DNN architectural configurations, or by transmitting data representative of the initial DNN architectural configuration itself to the test device.

With a CSF configuration selected and the test devices initialized with DNN architectural configurations based on the selected CSF configuration, at block 706 the training module 408 identifies one or more sets of training data for use in jointly training the DNNs of the DNN chain based on the selected CSF configuration and initial DNN architectural configurations. That is, the one or more sets of training data include or represent data that could be provided as input to a corresponding DNN in online operation, and thus suitable for training the DNNs. To illustrate, this training data can include a stream of test CSI pilot signals, test received representations of the test CSI pilot signals, test sensor data consistent with the sensors included in the configuration under test, test network status information consistent with the configuration under test, and the like.

With one or more training sets obtained, at block 708 the training module 408 initiates the joint training of the DNNs of the test CSF path. This joint training typically involves initializing the bias weights and coefficients of the various DNNs with initial values, which generally are selected pseudo-randomly, then inputting a set of training data at the TX processing module (e.g., CSF TX processing module 602) of the test receiving device, wirelessly transmitting the resulting output as a transmission to the RX processing module of the test receiving device (e.g., the CSF RX processing module 604), analyzing the resulting output, and then updating the DNN architectural configurations based on the analysis.

As is frequently employed for DNN training, feedback obtained as a result of the actual result output of the CSF RX processing module 604 is used to modify or otherwise refine parameters of one or more DNNs of the CSF path, such as through backpropagation. Accordingly, at block 710 the managing component 140 and/or the DNN chain itself obtains feedback for the transmitted training set. This feedback can be implemented in any of a variety of forms or combinations of forms. In some embodiments, the feedback includes the training module 408 or other training module determining an error between the actual result output and the expected result output, and backpropagating this error throughout the DNNs of the DNN chain. For example, as the processing by the DNN chain effectively provides a form of quantization or other encoding, the objective feedback on the training data set can some form of measurement of the accuracy of the recovered CSI estimate data obtained as output from the DNN chain compared to the original CSI estimate data provided as input to the DNN chain. The obtained feedback can also include evaluation metrics on some aspects of the signals as they traverse one or more links in the DNN chain. For example, relative to the RF aspects of the signaling, the feedback can include metrics such as such as block error rate (BER), signal-to-noise ratio (SNR), signal-to-interference-plus-noise ratio (SINR), and the like.

At block 712, the feedback obtained as a result of the transmission of the test data set through the DNN chain and presentation or other consumption of the resulting output at the test transmitting device is then used to update various aspects of one or more DNNs of the CSF path, such as through backpropagation of the error so as to change weights, connections, or layers of a corresponding DNN, or through managed modification by the managing component 140 in response to such feedback. The training process of blocks 706-712 is then performed for the next set of training data selected at the next iteration of block 706, and repeats until a certain number of training iterations have been performed or until a certain minimum error rate has been achieved.

As a result of the joint (or individual) training of the neural networks along the CSF path between a test transmitting device and test receiving device, each neural network has a particular neural network architectural configuration, or DNN architectural configuration in instances in which the implemented neural networks are DNNs, that characterizes the architecture and parameters of corresponding DNN, such as the number of hidden layers, the number of nodes at each layer, connections between each layer, the weights, coefficients, and other bias values implemented at each node, and the like. Accordingly, when the joint or individual training of the DNNs of the CSF path for a selected CSF configuration is complete, at block 714 some or all of the trained DNN configurations are distributed to the BS 108 and UEs 110 in the system 100, and each node stores the resulting DNN configurations of their corresponding DNNs as a DNN architectural configuration. In at least one embodiment, the DNN architectural configuration can be generated by extracting the architecture and parameters of the corresponding DNN, such as the number of hidden layers, number of nodes, connections, coefficients, weights, and other bias values, and the like, at the conclusion of the joint training. In other embodiments, the managing component 140 stores copies of the paired DNN architectural configurations as candidate neural network architectural configurations 144 of the set 142, and these DNN architectural configurations are then distributed to the BS 108 and UE 110 on an as-needed basis.

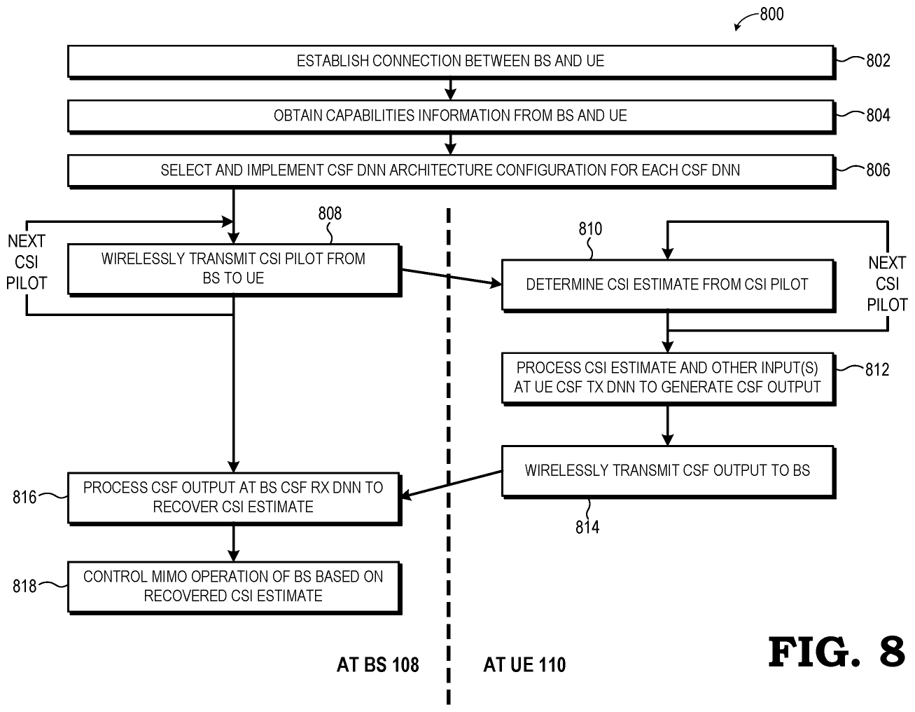

In the event that there are one or more other candidate CSF configurations remaining to be trained, then the method 700 returns to block 704 for the selection of the next candidate CSF configuration to be jointly trained, and another iteration of the subprocess of blocks 704-714 is repeated for the next CSF configuration selected by the training module 408. Otherwise, if the DNNs of the CSF path have been jointly trained for all intended CSF configurations, then method 700 completes and the system 100 can shift to neural-network-supported CSI estimate feedback, as described below with reference to FIGS. 8-12.

As noted above, the joint training process can be performed using offline test nodes (that is, while no active communications of control information or user-plane data are occurring) or while the actual nodes of the intended transmission path are online (that is, while active communications of control information or user-plane data are occurring). Further, in some embodiments, rather than training all of the DNNs jointly, in some instances, a subset of the DNNs can be trained or retrained while other DNNs are maintained as static. To illustrate, the managing component 140 may detect that the DNN of a particular device is operating inefficiently or incorrectly due to, for example, the presence of an undetected interferer in proximity to the device implementing the DNN or in response to a previously unreported loss of processing capacity, and thus the managing component 140 may schedule individual retraining of the DNN(s) of the device while maintaining the other DNNs of the other devices in their present configurations.

Further, it will be appreciated that, although there may be a wide variety of devices supporting a large number of CSF configurations, many different nodes may support the same or similar CSF configuration. Thus, rather than have to repeat the joint training for every device that is incorporated into the CSF path, following joint training of a representative device, that device can transmit a representation of its trained DNN architectural configuration for a CSF configuration to the managing component 140, and the managing component 140 can store the DNN architectural configuration and subsequently transmit it to other devices that support the same or similar CSF configuration for implementation in the DNNs of the CSF path.

Moreover, the DNN architectural configurations often will change over time as the corresponding devices operate using the DNNs. Thus, as operation progresses, the neural network management module of a given device (e.g., neural network management modules 222, 314) can be configured to transmit a representation of the updated architectural configurations of one or more of the DNNs employed at that node, such as by providing the updated gradients and related information, to the managing component 140 in response to a trigger. This trigger may be the expiration of a periodic timer, a query from the managing component 140, a determination that the magnitude of the changes has exceeded a specified threshold, and the like. The managing component 140 then incorporates these received DNN updates into the corresponding DNN architectural configuration and thus has an updated DNN architectural configuration available for distribution to the nodes in the transmission path as appropriate.

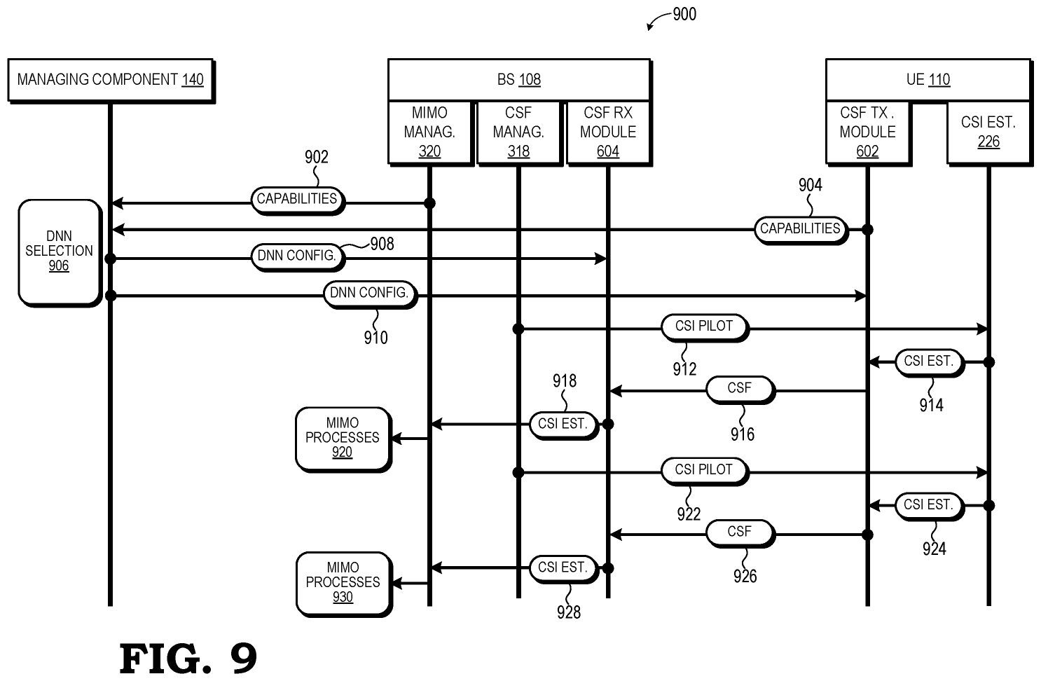

FIGS. 8 and 9 together illustrate an example method 800 for channel state feedback using a jointly trained DNN-based CSF path between wireless devices in accordance with some embodiments. For ease of discussion, the method 800 of FIG. 8 is described below in the example context of the CSF path 116 of FIGS. 1 and 6, in which the BS 108 operates as the transmitting device and the UE 110 operates as the receiving device. Further, the processes of method 800 are described with reference to the example transaction (ladder) diagram 900 of FIG. 9.

Method 800 initiates at block 802 with the BS 108 and the UE 110 establishing a wireless connection, such as via a 5G NR stand-alone registration/attach process in a cellular context or via an IEEE 802.11 association process in a WLAN context. At block 804, the managing component 140 obtains capability information from each of the BS 108 and the UE 110, such as capability information 902 (FIG. 9) provided by the capabilities management module 316 (FIG. 3) of the BS 108 and the capability information 904 (FIG. 9) provided by the capabilities management module 224 (FIG. 2) of the UE 110. In some embodiments, the managing component 140 may already be informed of the capabilities of the BS 108 when it is part of the same infrastructure network, in which case obtaining the capability information 902 for the BS 108 can include accessing a local or remote database or other data store for this information. For the UE 110, the BS 108 can send a capabilities request to the UE 110, and the UE 110 responds to this request with the capability information 904, which the BS 108 then forwards on to the managing component 140. For example, the BS 108 can send a UECapabilityEnquiry RRC message, which the UE 110 responds to with a UECapabilityInformation RRC message that contains the CSI-relevant capability information.

At block 806, the neural network selection module 410 of the managing component 140 uses the capability information and other information representative of the CSF configuration between the BS 108 and the UE 110 to select a pair of CSF DNN architectural configurations to be implemented at the BS 108 and the UE 110 for supporting the CSF path 116 (DNN selection 906, FIG. 9). In some embodiments, the neural network selection module 410 employs an algorithmic selection process in which the capability information obtained from the BS 108 and UE 110 and the CSF configuration parameters of the CSF path 116 are compared to the attributes of pairs of candidate neural network architectural configurations 144 in the set 142 to identify a suitable pair of DNN architectural configurations. In other embodiments, the neural network selection module 410 may organize the candidate DNN architectural configurations in one or more LUTs, with each entry storing a corresponding pair of DNN architectural configurations and being indexed by a corresponding combination of input parameters or parameter ranges, and thus the neural network selection module 410 may select a suitable pair of DNN architectural configurations to be employed by the BS 108 and the UE 110 via the provision of the capabilities and CSF configuration parameters identified at block 804 as inputs to the one or more LUTs.

Further at block 806, the managing component 140 directs the BS 108 and the UE 110 to implement their respective DNN architectural configuration from the selected jointly trained pair of DNN architectural configurations. In implementations in which each of the BS 108 and the UE 110 stores candidate DNN architectural configurations for potential future use, the managing component 140 can transmit a message with an identifier of the DNN architectural configuration to be implemented. Otherwise, the managing component 140 can transmit information representative of the DNN architectural configuration as, for example, a Layer 1 signal, a Layer 2 control element, a Layer 3 RRC message, or a combination thereof. For example, with reference to FIG. 9, the managing component 140 sends to the BS 108 a DNN configuration message 908 that contains data representative of the DNN architectural configuration selected for the BS 108. In response to receiving this message, the neural network management module 314 of the BS 108 extracts the data from the DNN configuration message 908 and configures the CSF RX processing module 604 to implement one or more DNNs having the DNN architectural configuration represented in the extracted data. Similarly, the managing component 140 sends to the UE 110 a DNN configuration message 910 that contains data representative of the DNN architectural configuration selected for the UE 110. In response to receiving this message, the neural network management module 222 of the UE 110 extracts the data from the DNN configuration message 910 and configures the CSF TX processing module 602 to implement one or more DNNs having the DNN architectural configuration represented in the extracted data.

With the DNNs of the CSF path 116 being initially configured, the CSI estimate and feedback process can begin. Accordingly, at block 808 the CSF management module 318 of the BS 108 selects or otherwise identifies a CSI pilot signal 912 (FIG. 9) based on the CSF configuration of the CSF path 116 (which may include, for example, the particular beams, antennas, subcarriers, etc., to be employed) and provides for the wireless transmission of the CSI pilot signal 912 to the UE 110. At block 810, the UE 110 receives the one or more RF signals representative of the transmitted CSI pilot signal 912, converts the one or more RF signals to one or more corresponding baseband signals, and then the CSI estimation module 226 analyzes the one or more baseband signals to determine a CSI estimate 914 (FIG. 9). As noted above, any of a variety of CSI estimate techniques can be employed by the CSI estimation module 226 to determine the CSI estimate.

At block 812, the CSF TX processing module 602 receives the CSI estimate 914 as an input, optionally along with one or more other inputs, such as sensor data from sensors of the UE 110, scheduling latency information representing the scheduling latency in the use of CSI estimates at the BS 108, and/or current network status information from the RF antenna interface 204 of the UE 110, and from these inputs generates a CSF output 916 (FIG. 9) that represents the CSI estimate 914 in a quantized or otherwise encoded form. At block 814, the resulting CSF output 916 is wirelessly transmitted from the UE 110 to the BS 108.

At block 816, the one or more RF signals representative of the CSF output 916 are received and processed by the RF front end 304 of the BS 108, and the resulting output is provided as an input to the CSF RX processing module 604 of the BS 108, optionally along with one or more other inputs, such as sensor data from the sensor set 310 of the BS 108, current network status information obtained by the BS 108, and the like. The one or more DNNs of the CSF RX processing module 604 generate a recovered representation of the CSI estimate 914 (recovered CSI estimate 918, FIG. 9) based on these inputs. At block 818, the recovered CSI estimate 918 is provided to the MIMO management module 320, which uses the CSI estimate 918 to modify or otherwise control one or more MIMO processes 920 accordingly. As noted above, the CSF TX processing module 602 at the UE 110 further may consider the scheduling latency of the BS 108 in generating the CSI output such that the CSI estimate 914 is modified during processing by the CSF TX processing module 602 so as to reflect a predicted future version of the CSI estimate such that the recovered CSI estimate 918 represents the CSI estimate as it is predicted to be during the period in which the MIMO management module 320 is scheduled to use the CSI estimate in controlling MIMO processes.

Typically, the CSI estimation process involves sending out a series of CSI pilot signals, with each CSI pilot signal (or a subset of CSI pilot signals) configured for use in characterizing a particular subchannel or carrier frequency of a set of subchannels/carrier frequencies. Accordingly, the process of blocks 808 to 818 can be repeated for each CSI pilot signal in such a sequence. For example, in a next iteration of this process, a CSI pilot signal 922 (FIG. 9) can be selected for channel estimation of another subcarrier, and transmitted from the BS 108 to the UE 110. The CSI estimation module 225 processes a received version of the CSI pilot signal 922 to determine a CSI estimate 924 (FIG. 9) for that subcarrier, and the CSI estimate 924 is provided as an input to the CSF TX processing module 602 along with other inputs to generate an encoded representation of the CSI estimate 924 in the form of a CSF output 926 (FIG. 9). The CSF output 926 is then wirelessly transmitted to the BS 108, whereupon the recovered representation of the CSF output 926 is provided as an input to the CSF RX processing module 604, which uses this input and optionally one or more other inputs to generate a recovered representation of the CSI estimate 924 (recovered CSI estimate 928, FIG. 9), which in turn can be used to modify or otherwise control one or more MIMO processes 930 (FIG. 9) at the BS 108.

Further, although method 800 of FIG. 8 and the corresponding example operation of ladder diagram 900 of FIG. 9 illustrate an implementation in which each CSI estimate generated at the UE 110 is used to generate a corresponding separate CSF output, in other embodiments, rather than generate a new CSF output for each CSI estimate generated at the UE 110, the UE 110 can be configured to generate and temporarily store the CSI estimates for some or all of the entire series of CSI pilot signals sent by the BS 108 for a given CSF iteration, and then provide the resulting set of CSI estimates as a single data block (e.g., CSI estimate data block 134, FIG. 1) in the form of a CSI estimate matrix or other data structure, as an input to the CSF TX processing module 602 for generation of a single CSF output representative of the set of CSI estimates.

Thus far, the system 100 has been described in the context of embodiments in which a conventional CSI pilot transmission and CSI estimation process is employed in conjunction with a neural-network-based channel state feedback path for providing the resulting CSI estimates back to the transmitting device. However, the system 100 is not limited to this approach and instead may employ jointly trained DNNs or other neural networks for each of the CSI pilot transmission, CSI estimation, and CSI feedback processes. To this end, FIG. 10 illustrates an example operating environment 1000 in which the CSI pilot transmission, CSI estimation, and CSI feedback processes are implemented using a jointly trained set of DNNs or other neural networks at the transmitting device and receiving device. For ease of illustration, the operating environment is described in the example context of the BS 108 as the transmitting device and the UE 110 as the receiving device. The principles disclosed apply equally to an example with the UE 110 as the transmitting device and the BS 108 as the receiving device as well as sidelink examples.

In the depicted example operating environment 1000, the neural network management module 314 of the BS 108 employs a CSF TX processing module 1002 and a CSF RX processing module 1008, while the neural network management module 222 of the UE 110 implements a CSF RX processing module 1004 and a CSF TX processing module 1006. In at least one embodiment, each of these processing modules implements one or more DNNs via the implementation of a corresponding ML module, such as described above with reference to the one or more DNNs 502 of the ML module 500 of FIG. 5.

The processing modules 1002, 1004, 1006, and 1008 together operate to provide CSF in a manner that reduces or eliminates the use of a complex, hardcoded CSF process in favor of a trained neural-network-based approach that can be adapted to the current operating parameters of the BS 108 and UE 110, as well as being adaptable to changes in these operating parameters. To this end, the candidate neural network architectural configurations can be jointly trained as described above with reference to the method 700 of FIG. 7, and the managing component 140 or other component in the system 100 can select the particular set of neural network architectural configurations to be employed for these processing modules from the jointly trained candidates using a selection process as similarly described above.

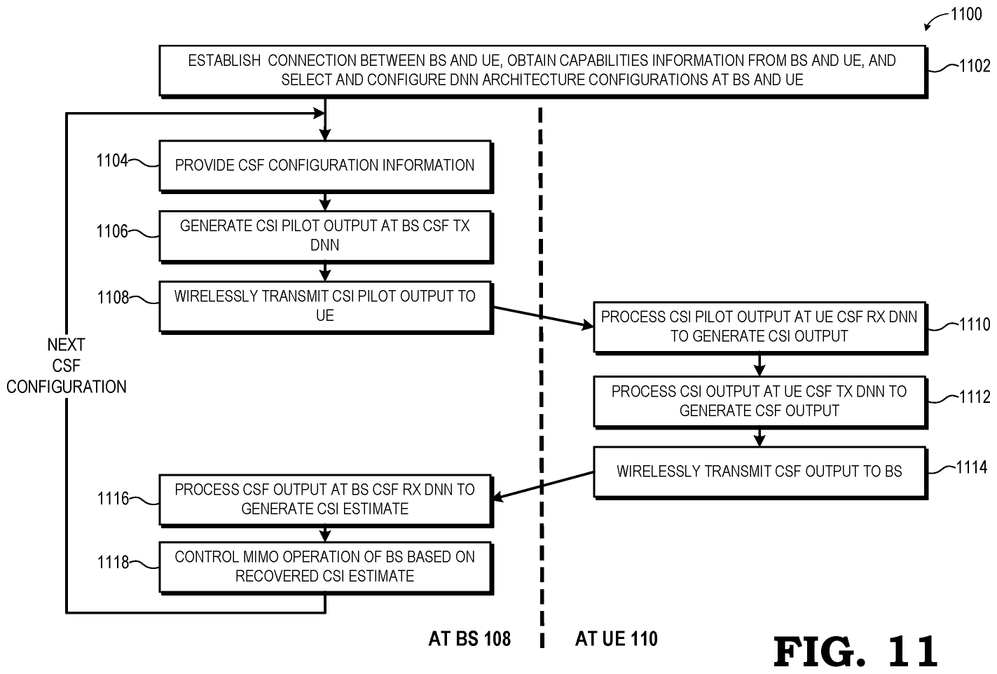

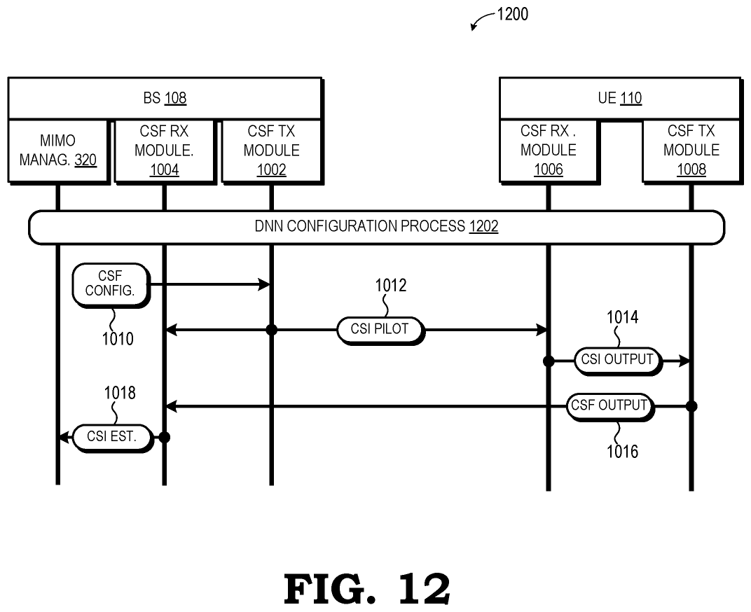

FIG. 11 illustrates an example method 1100 of operation of the operating environment 1000 of FIG. 10 in accordance with some embodiments. To facilitate understanding, the method 1100 is described with reference to an example transaction (ladder) diagram 1200 of FIG. 12. The method 1100 initiates at block 1102 in which the BS 108 and the UE 110 establish an initial connection and the managing component 140 obtains the CSF-relevant capability information from the BS 108 and UE 110, as described above with reference to blocks 802, 804 (FIG. 8). As also similarly described above with reference to block 806, the managing component 140 selects a set of DNN architectural configurations to be employed by the processing modules 1002, 1004, 1006, and 1008 based on the obtained capability information and any CSF configuration information provided, and directs the BS 108 and UE 110 to implement the selected DNN architectural configurations. This process is represented as DNN configuration process 1202 in the transaction diagram 1200.

At block 1104, the CSF management module 318 generates a CSF configuration input 1010 (FIGS. 10, 12) that is composed of information representative of the current CSF configuration in which the BS 108 and the UE 110 are to jointly cooperate to provide CSI for use by the BS 108 in downlink communications with the UE 110. This information can include, for example, a particular subset of beams to be employed, a particular subset of carrier frequencies to be employed, a particular number of antenna ports to be employed, specified power efficiency targets, an indication of whether the RF signaling is expected to be line of sight (LoS) or multipath, or some combination thereof.

At block 1106, the CSF configuration input 1010 is provided as an input to the CSF TX processing module 1002 of the BS 108, optionally along with one or more other inputs, such as current sensor data from the sensor set 310 or current network status information as observed by the BS 108 (these inputs are omitted from FIG. 10 for ease of illustration). Based on the CSF configuration input 1010 and the other input(s), the CSF TX processing module 1002 operates to generate a CSI pilot output 1012 (FIG. 10, FIG. 12) that, in effect, represents one or more CSI pilot signals that reflect the current CSF configuration as represented in the CSF configuration input 1010. At block 1108, the CSI pilot output 1012 is then wirelessly transmitted to the UE 110. Further, the CSI pilot output 1012 is also provided as an input to the CSF RX processing module 1008 of the BS 108, which will use this input optionally along with other inputs, such as sensor data or current network status information, to recover CSI estimate information from DNN-generated output at the UE 110, as described below.

At block 1110, the UE 110 processes the received wireless signals representing the CSI pilot output 1012 and provides the result as an input to the CSF RX processing module 1006 at the UE 110, optionally along with one or more other inputs such as sensor data from the sensor set 210 of the UE 110 or current network status information as observed by the UE 110 (omitted from FIG. 10 for ease of illustration). The CSF RX processing module 1006 then uses these inputs to generate a corresponding CSI output 1014 (FIG. 10, FIG. 12) that, in effect, represents one or more CSI estimates for some or all of the subchannel/beam/antenna port combinations represented in the CSF configuration information 1010 and generated from the CSI pilot information represented by the received CSI pilot output 1012. That is, the CSF TX processing module 1002 and the CSF RX processing module 1006 can be jointly trained to provide, in effect, an equivalent of the conventional algorithmic CSI pilot transmission and CSI estimate calculation process, but in which the processing modules 1002 and 1006 further can incorporate current operational parameters in the form of current sensor input and current network status to better adapt to the current transmission environment, as well as scheduling latency information to better predict the CSI estimate information for the period during which the BS 108 is to use the CSI estimate information being generated.

At block 1112, the CSF TX module 1006 receives the CSI output 1014 as an input, optionally along with sensor data, network status data, or other data as one or more other inputs, and from these inputs generates a CSF output 1016 (FIGS. 10, 12) that, in effect, represents a compressed or otherwise encoded representation of the CSI estimate information represented in the CSI output 1014, and which is adapted to current operational contexts as represented in the sensor data, network status information, scheduling latency, and other inputs. At block 1114 the UE 110 wirelessly transmits the CSF output 1016 to the BS 108.

At block 1116, the BS 108 processes the wireless signals representing the CSF output 1016 and provides the resulting output that represents a recovered CSI representation of the CSF output 1016 to the CSF RX processing module 1008. The CSF RX processing module 1008 uses this input, along with the CSI pilot output 1012 as an input, and optionally further with one or more other inputs such as sensor data and current network status information observed at the BS 108, to generate a CSI estimate output 1018 that represents a recovered representation of the CSI estimate information represented in the CSI output 1014 generated by the CSF RX processing module 1004 of the UE 110 based on a received representation of the CSI pilot output 1012 generated by the CSF TX processing module 1002 of the BS 108. That is, the DNNs of the processing modules 1006 and 1008, in one embodiment, are jointly trained to provide, in effect, an equivalent of a conventional hardcoded CSI feedback process in which CSI estimates are encoded for transmission, but in which the processing modules 1006 and 1008 further can incorporate current operational parameters in the form of current sensor input and current network status to better adapt to the current transmission environment. At block 1118, the CSI estimate information represented in the CSI estimate output 1018 then is provided to the MIMO management module 320 for use in controlling one or more MIMO processes being employed at the BS 108.

Typically, changes in the operating environment may necessitate recalibration, or recalculation of the CSI estimates provided during the most recent iteration of the process of blocks 1104 to 1118. For example, the location of the UE 110 may have sufficiently changed to necessitate recalculation, the antenna patterns of one or both of the BS 108 or the UE 110 may have substantially changed, and the like. Accordingly, the process of blocks 1104 to 1118 can be repeated to update the CSI estimates being used by the BS 108 for controlling certain MIMO operations. The triggering of another iteration of the process of blocks 1104 to 1118 can be based on a timer or other periodic reference. For example, the BS 108 or the managing component 140 may trigger another iteration based on the lapse of a timer. In other embodiments, the timing of an iteration trigger may be trained into the DNNs themselves, such that the CSF TX processing module 1002 of the BS 108 may be trained to trigger another iteration based on a timer, based on a particular sensor data input or network status input, and the like.

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A computer-implemented method, in a first device, comprising:
receiving an indication of a neural network architectural configuration responsive to providing capability information representing at least one capability of the first device to an infrastructure component;
implementing the neural network architectural configuration at a transmit neural network of the first device, wherein the transmit neural network is paired with a jointly trained receive neural network configured to receive and process output from the transmit neural network;
receiving a representation of a channel status information (CSI) estimate as an input to the transmit neural network;
generating, at the transmit neural network, a first output based on the representation of the CSI estimate, the first output representing a compressed version of the representation of a prediction of the CSI estimate for a future point in time; and
controlling a radio frequency (RF) antenna interface of the first device to transmit a first RF signal representative of the first output for receipt by a second device implementing the receive neural network.

2. The method of claim 1, further comprising:
algorithmically determining the CSI estimate based on one or more RF signals received from the second device.

3. The method of claim 1, wherein generating the first output further comprises generating the first output at the transmit neural network further based on a representation of a scheduling latency of a multiple-input multiple-output (MIMO) process of the second device provided as an input to the transmit neural network.

4. The method of claim 3, wherein the neural network architectural configuration is selected for the transmit neural network from a plurality of candidate neural network architectural configurations based on the scheduling latency.

5. The method of claim 1, wherein generating the first output comprises generating the first output at the transmit neural network further based on sensor data input to the transmit neural network from one or more sensors of the first device.

6. The method of claim 1, further comprising:
receiving a representation of a CSI pilot signal as an input of a receive neural network of the first device; and
generating, at the receive neural network, a second output based on the representation of the CSI pilot signal, the second output including the representation of the CSI estimate.

7. The method of claim 6, wherein generating the second output further comprises generating the second output at the receive neural network based on at least one of: sensor data from one or more sensors of the first device or a carrier frequency of a channel associated with the CSI estimate.

8. A computer-implemented method, in a first device, comprising:
receiving an indication of a neural network architectural configuration responsive to providing capability information representing at least one capability of the first device to an infrastructure component;
implementing the neural network architectural configuration at a receive neural network of the first device, wherein the receive neural network is paired with a jointly trained transmit neural network configured to transmit output to the receive neural network;
receiving, at a radio frequency (RF) antenna interface of the first device, a first RF signal from a second device implementing the transmit neural network, the first RF signal representative of a compressed representation of a predicted future channel state information (CSI) estimate;
providing a representation of the first RF signal as an input to the receive neural network;
generating, at the receive neural network, the predicted future CSI estimate based on the input to the receive neural network; and
managing at least one multiple-input multiple-output (MIMO) process at the first device based on the predicted future CSI estimate.

9. The method of claim 8, wherein generating the predicted future CSI estimate further comprises generating the predicted future CSI estimate at the receive neural network further based on a representation of a scheduling latency of a MIMO process of the first device provided as an input to the receive neural network.

10. The method of claim 9, wherein the neural network architectural configuration is selected for the receive neural network from a plurality of candidate neural network architectural configurations based on the scheduling latency.

11. The method of claim 8, wherein generating the predicted future CSI estimate comprises generating the predicted future CSI estimate at the receive neural network further based on sensor data input to the receive neural network from one or more sensors of the first device.

12. The method of claim 1, wherein the neural network architectural configuration is selected from a plurality of neural network architectural configurations based on at least one of: the at least one capability of the first device or a current signal propagation environment of the first device.

13. The method of claim 1, wherein receiving the indication of the neural network architectural configuration comprises at least one of:
receiving an identifier associated with one of a plurality of candidate neural network architectural configurations locally stored at the first device; or
receiving one or more data structures representing parameters of the neural network architectural configuration.

14. The method of claim 8, further comprising:
generating, at a transmit neural network of the first device, a CSI pilot signal; and
controlling the RF antenna interface of the first device to transmit a second RF signal representative of the CSI pilot signal for receipt by the second device.

15. The method of claim 14, wherein generating the CSI pilot signal comprises generating the CSI pilot signal at the transmit neural network further based on at least one of: a carrier frequency of a channel associated with the CSI estimate; at least one operational parameter for the RF antenna interface of the first device; or sensor data from one or more sensors of the first device; or a carrier frequency of a channel associated with the CSI estimate.

16. The method of claim 8, wherein generating the predicted future CSI estimate further comprises generating the predicted future CSI estimate at the transmit neural network based on at least one of: sensor data from one or more sensors of the first device or a carrier frequency of a channel associated with the predicted future CSI estimate.

17. The method of claim 8, wherein the at least one MIMO process comprises at least one of: a beamforming process; a space-time coding process; or a multiple-user MIMO process.

18. The method of claim 1, wherein the at least one capability comprises at least one of: a processing capability; a power capability; or a sensor capability.

19. A device comprising:
a radio frequency (RF) antenna interface;
at least one processor coupled to the RF antenna interface; and
a memory storing executable instructions, the executable instructions configured to manipulate the at least one processor to perform the method of claim 1.

20. A device comprising:
a radio frequency (RF) antenna interface;
at least one processor coupled to the RF antenna interface; and
a memory storing executable instructions, the executable instructions configured to manipulate the at least one processor to perform the method of claim 8.
